(19) United States
(12) Patent Application Publication
(10) Pub. No.: US 2017/0090320 A1
(43) Pub. Date: Mar. 30, 2017

(54) BRILLIANT TONER, ELECTROSTATIC CHARGE IMAGE DEVELOPER, AND TONER CARTRIDGE

(71) Applicant: FUJI XEROX CO., LTD., Tokyo (JP)

(72) Inventors: Tetsuya TAGUCHI, Kanagawa (JP); Shotaro TAKAHASHI, Kanagawa (JP); Daisuke NOGUCHI, Kanagawa (JP)

(73) Assignee: FUJI XEROX CO., LTD., Tokyo (JP)

(21) Appl. No.: 15/053,584

(22) Filed: Feb. 25, 2016

(30) Foreign Application Priority Data
Sep. 25, 2015 (JP) 2015-188618

(51) Int. Cl. G03G 9/00

(52) U.S. Cl. CPC G03G 9/0902; G03G 9/0821; G03G 9/0926; G03G 9/08755; G03G 9/0827

(57) ABSTRACT

A brilliant toner includes a brilliant pigment and a binder resin, wherein, when the toner is subjected to a differential scanning calorimetry measurement performed by raising a temperature of the toner from 0° C. to 150° C. in a first temperature rising process, cooling the temperature from 150° C. to 0° C., and then raising the temperature from 0° C. to 150° C. in a second temperature rising process, the toner exhibits an endothermic peak P1 in a range of 50° C. to 65° C. in the first temperature rising process, an endothermic peak P2 in a range of 50° C. to 65° C. in the second temperature rising process, and a ratio (Q2/Q1) between a total endothermic quantity Q1 in a range of 50° C. to 65° C. in the first temperature rising process and a total endothermic quantity Q2 in a range of 50° C. to 65° C. in the second temperature rising process is from 0.01 to 0.30.

### CROSS-REFERENCE TO RELATED APPLICATIONS

This application is based on and claims priority under 35 USC 119 from Japanese Patent Application No. 2015-188618 filed Sep. 25, 2015.

### BACKGROUND

1. Technical Field

The present invention relates to a brilliant toner, an electrostatic charge image developer, and a toner cartridge.

2. Related Art

In recent years, for the purpose of forming an image having brilliance similar to metallic luster, the use of brilliant toners including a brilliant pigment has been considered.

### SUMMARY

According to an aspect of the invention, there is provided a brilliant toner, at least including:

a brilliant pigment; and

a binder resin,

wherein, when the toner is subjected to a differential scanning calorimetry measurement which is performed by raising a temperature of the toner from 0° C. to 150° C. in a first temperature rising process, cooling the temperature from 150° C. to 0° C., and then raising the temperature from 0° C. to 150° C. in a second temperature rising process,

the toner exhibits an endothermic peak P1 in a range of 50° C. to 65° C. in the first temperature rising process,

an endothermic peak P2 in a range of 50° C. to 65° C. in the second temperature rising process, and

a ratio (Q2/Q1) between a total endothermic quantity Q1 in a range of 50° C. to 65° C. in the first temperature rising process and a total endothermic quantity Q2 in a range of 50° C. to 65° C. in the second temperature rising process is from 0.01 to 0.30.

### BRIEF DESCRIPTION OF THE DRAWINGS

Exemplary embodiments of the present invention will be described in detail based on the following figures, wherein:

FIG. 1 is a cross-sectional view schematically showing a toner according to an exemplary embodiment;

FIG. 2 is a view for explaining the state of a screw in an example of a screw extruder used for preparation of the toner according to the exemplary embodiment;

FIG. 3 is a schematic configuration view showing an example of an image forming apparatus according to an exemplary embodiment; and

FIG. 4 is a schematic configuration view showing an example of a process cartridge according to an exemplary embodiment.

### DETAILED DESCRIPTION

Exemplary embodiments of a brilliant toner, an electrostatic charge image developer, a toner cartridge, a process cartridge, an image forming apparatus, and an image forming method according to the present invention will be described in detail.

Brilliant Toner

A brilliant toner according to an exemplary embodiment (hereinafter, sometimes referred to as “toner”) includes at least a brilliant pigment and a binder resin. The brilliant toner has an endothermic peak P1 in a range of 50° C. to 65° C. when the temperature is raised from 0° C. to 150° C. in a first temperature rising process and an endothermic peak P2 in a range of 50° C. to 65° C. when the toner is cooled to 0° C. after the temperature is raised to 150° C. in the first temperature rising process and then the temperature is raised from 0° C. to 150° C. in a second temperature rising process in differential scanning calorimetry measurement, and a ratio (Q2/Q1) between the total endothermic quantity Q1 in a range of 50° C. to 65° C. in the first temperature rising process and the total endothermic quantity Q2 in a range of 50° C. to 65° C. in the second temperature rising process is from 0.01 to 0.30.

When paper is curled by drawing the paper while pressing the paper against a rod or the like, paper is supplied along a guide having a large curvature to change the feeding direction of the paper in a sheet feeding portion for an image forming apparatus adopting an electrophotographic system, or the like, stress is applied to the paper so that the paper is subjected to ironing in some cases (hereinafter referred to as “ironing”).

In the brilliant toner, a brilliant pigment and a binder resin are used, and when a brilliant image portion after fixing is subjected to ironing, brilliance may be remarkably deteriorated.

When the image portion after fixing is subjected to ironing, the binder resin fixed in the image portion is deformed together with the paper. The color toner of the related art includes a pigment or a dye as a coloring agent but the particle size of these coloring agents is small, which is 1 μm or less, and in most cases, several hundreds nm or less. Therefore, these coloring agents move according to the deformation of the binder resin in the binder resin of the image portion and thus a fixed image is not easily damaged.

On the other hand, since in the brilliant toner, a brilliant pigment is used, some of incident light that enters an image is specularly reflected to exhibit brilliance. In order to increase the specular reflectance, the brilliant pigment has larger and flakier particles than the color toner of the related art.

When the brilliant image portion formed by using the brilliant pigment is subjected to ironing, the brilliant pigment is also deformed. At this time, since the deformability of the binder resin and the deformability of the brilliant pigment are different, the binder resin near the brilliant pigment is easily cracked or peeled off. The binder resin in the image portion is interposed between the brilliant pigment in the image and an object that contacts the image portion at the time of ironing and receives a strong force, which is considered as one factor for causing cracking or peeling-off of the binder resin.

When the binder resin is cracked, diffuse reflection of light occurs at the cracked interface and thus incident light that enters the brilliant pigment is reduced or specular reflective light reflected from the brilliant pigment is reduced. Thus, brilliance is deteriorated.

As a result of intensive investigations conducted by the inventors, it has been found that when an image, formed using a brilliant toner which has an endothermic peak P1 in a range of 50° C. to 65° C. when the temperature is raised from 0° C. to 150° C. in a first temperature rising process and an endothermic peak P2 in a range of 50° C. to 65° C. when the toner is cooled to 0° C. after the temperature is raised to 150° C. in the first temperature rising process and then the temperature is raised from 0° C. to 150° C. in a second temperature rising process in differential scanning calorimetry measurement, in which a ratio (Q2/Q1) between the total endothermic quantity Q1 in a range of 50° C. to 65° C. in the first temperature rising process and the total endothermic quantity Q2 in a range of 50° C. to 65° C. in the second temperature rising process satisfies a relationship of 0.01 to 0.30, is subjected to ironing, the brilliance is rarely deteriorated.

Although the details of a mechanism of preventing brilliance deterioration are not clear, it is considered as follows.

The fact that the total endothermic quantity Q2 in a range of 50° C. to 65° C. in the second temperature rising process is smaller than the total endothermic quantity Q1 in a range of 50° C. to 65° C. in the first temperature rising process means that the crystallinity of the binder resin is reduced and thus the molecular motion of the binder resin easily occurs. The crystalline portion of the binder resin is rigid and brittle and thus easily cracked. However, when the crystallinity of the binder resin is low and the molecular motion is active, the resin is easily deformed. Therefore, it is considered that the toughness of the resin against deformation and impact is improved.

An unfixed toner image on paper as a recording medium adheres to the paper by melting of the binder resin due to heat or pressure applied from a fixing member of an image forming apparatus and is cooled and solidified on the paper. Thus, a fixed toner image is obtained. Therefore, it is presumed that when a brilliant image is subjected to ironing, brilliance deterioration is prevented by using a brilliant toner in which the total endothermic quantity Q2 in a range of 50° C. to 65° C. in the second temperature rising process after cooling after the first temperature rising process becomes smaller.

In the exemplary embodiment, when the ratio (Q2/Q1) is greater than 0.30, the molecular motion of the binder resin is not sufficient and thus a sufficient effect of preventing brilliance deterioration at the time of ironing is not exhibited. Therefore, it is presumed that the crystallinity of the binder resin is high.

When the ratio (Q2/Q1) is less than 0.01, the molecular motion of the binder resin is excessive and thus the binder resin on the surface of the image is deformed at the time of ironing, which is a factor for causing diffuse reflection of light. Therefore, it is presumed that the brilliance is deteriorated.

In the exemplary embodiment, the ratio (Q2/Q1) is preferably from 0.02 to 0.28 and more preferably from 0.05 to 0.25.

In the exemplary embodiment, the total endothermic quantity Q1 is preferably from 1 J/g to 40 J/g and more preferably from 2 J/g to 30 J/g.

In addition, since a toner that does not have an endothermic peak P1 in a range of 50° C. to 65° C. in a first temperature rising process is not easily melted, adhesion to a recording medium such as paper is low and the image is remarkably damaged. Thus, the brilliance is remarkably deteriorated at the time of ironing.

Further, since in a toner that does not have an endothermic peak P2 in a range of 50° C. to 65° C. in a second temperature rising process, the binder resin easily moves, and the surface of the image is easily damaged or when printed documents are stored in a superimposed state, the image is transferred to another recording medium and contaminated.

It is preferable that the toner according to the exemplary embodiment does not have an endothermic peak in a range of lower than 50° C. when the temperature is raised from 0° C. to 150° C. in the first temperature rising process in the differential scanning calorimetry measurement.

The toner according to the exemplary embodiment includes a brilliant pigment. However, the specific gravity of the brilliant pigment is heavy, and thus the brilliant toner is easily settled in a developer unit or a toner cartridge by vibrations at the time of driving an image forming apparatus. When a brilliant image is not formed, in a state in which a developing device portion or a toner replenishing device portion for the brilliant toner is not driven, the brilliant toner is affected by vibrations of an image forming apparatus and a rising temperature, and thus aggregates of the brilliant toner are easily formed in a developer unit or a toner cartridge. It is presumed that when the toner according to the exemplary embodiment does not have an endothermic peak in a range of lower than 50° C., the toner is not easily softened even when heat inside an image forming apparatus is applied to the binder resin of the toner, and thus toner aggregates are prevented from being formed.

For example, the specific gravity of aluminum as a raw material of the brilliant pigment is 2.7 g/cm³, the specific gravity of brass is 8.5 g/cm³, and the specific gravity of mica is 2.8 g/cm³. In addition, the specific gravity of the binder resin is from about 1.0 g/cm³ to about 1.2 g/cm³.

In the exemplary embodiment, the determination of the total endothermic quantity Q1 and the total endothermic quantity Q2 by differential scanning calorimetry measurement is performed as follows.

The differential scanning calorimetry measurement is performed using a differential scanning calorimeter (DSC) according to ASTM D3418-8. The differential scanning calorimetry measurement is performed using a differential scanning calorimeter (DSC3110, thermal analysis system 001, manufactured by Mack Science Co.) equipped with an automatic tangent line processing system, which is also used as a liquid nitrogen cooling device, under the conditions of a sample amount of 8 mg to 10 mg and a measurement temperature range of 0° C. to 150° C. First, as the first measurement, the temperature is raised from 0° C. at a temperature rising rate of 10° C. per minute, and the temperature is held for 5 minutes after the temperature reaches 150° C. Thereafter, the toner is cooled to 0° C. at a temperature falling rate of −10° C. per minute using the liquid nitrogen cooling device and the temperature is held for 5 minutes. Then, for the second measurement, under the same conditions as those of the first measurement, the temperature is raised to 150° C. At this time, spectra obtained in the first and second temperature rising processes are respectively defined as a first temperature rising spectrum and a second temperature rising spectrum.

The entire spectrum of each of the first temperature rising spectrum and the second temperature rising spectrum is shifted such that the endothermic quantity at 20° C. becomes 0, and a deviation of the base line is corrected. In addition, the measured spectrum is divided by the amount of the sample used in the measurement to calculate spectrum intensity per unit weight and a deviation of the spectrum intensity due to the sample amount is corrected.

Using the spectrum corrected as described above, the presence or absence of an endothermic peak in a range of 50° C. to 65° C. in the first temperature rising spectrum is confirmed and the endothermic quantity calculated from the area of the endothermic peak is defined as a heat quantity Q1. In the same manner, the endothermic quantity of an endothermic peak in a range of 50° C. to 65° C. in the second temperature rising spectrum is defined as a heat quantity Q2. The total endothermic quantity Q1 and the total endothermic quantity Q2 are values corrected by the amount of the sample used in the measurement and are respectively set to an endothermic quantity per sample unit weight.

The numerical values shown in the specification are calculated by the above-described method.

In the exemplary embodiment, in order to set the ratio (Q2/Q1) to be in a range of 0.01 to 0.30, a method of using a urea-modified polyester resin as binder resins, a method of adjusting the amount of a portion insoluble in toluene (hereinafter referred to as “toluene insoluble portion”) in a toner, a method of using both an amorphous resin and a crystalline resin as a binder resin, a method of using a plasticizer, a method of using a crystallization agent, and the like may be used.

The content of the toluene insoluble portion except for an inorganic substance in the toner according to the exemplary embodiment is preferably from 0.1% by weight to 50% by weight, more preferably from 2% by weight to 30% by weight, and still more preferably from 3% by weight to 10% by weight with respect to the total toner.

The toluene insoluble portion is adjusted by, for example, 1) a method of forming a crosslinked structure by adding a crosslinking agent to a polymer component having a reactive functional group at the end or a branched structure, 2) a method of forming a crosslinked structure or a branched structure in a polymer component having an ionic functional group at the end by using polyvalent metal ions, and 3) a method of extending or branching the length of a resin chain with a treatment with isocyanate or the like.

Here, the toluene insoluble portion is a constituent component excluding an inorganic substance among toner constituting components which are not soluble in toluene. However, in the case in which the toner particles include a release agent, besides the brilliant pigment and the binder resin, the toluene insoluble portion is a toluene insoluble portion excluding not only an inorganic substance but also the release agent. That is, the toluene insoluble portion is composed of an insoluble portion having a binder resin component which is insoluble in toluene (particularly a high molecular weight component of a binder resin) as a main component (for example, 90% by weight or more with respect to the total amount). A non-brilliant pigment or an external additive, besides the brilliant pigment, may correspond to the inorganic substance.

The toluene insoluble portion has a value measured by the following method.

First, toner particles as an object to be measured are embedded using a bisphenol A type liquid epoxy resin and a curing agent and a sample for cutting is prepared. Next, the sample for cutting is cut at −100° C. by using a cutting machine, for example, a Ultracut UCT (manufactured by Leica Microsystems) using a diamond knife to prepare sample segments.

Using a scanning electron microscope (SEM-EDX) with an energy dispersion type X-ray analyzer, the cross section of the sample segment is observed and the constituent elements of an inorganic substance present in the toner (a flake-shaped brilliant pigment (which is observed as a needle-shape in the cross section), an external additive, in the case in which an external additive is externally added to the toner particles, and the like) are identified using an energy dispersion type X-ray analyzer (EDX). In addition, in the case in which an external additive is externally added to the toner particles, the constituent elements of the external additive are also identified. Then, using a fluorescent X-ray analyzer, the amount of the inorganic substance (% by weight) is determined.

Here, using an analyzer in which an energy dispersion type X-ray analyzer “EMAX model 6923 H”, manufactured by HORIBA, Ltd., is mounted on an electron microscope “S-4100” manufactured by Hitachi Co., Ltd. as the scanning electron microscope equipped with an energy dispersion type X-ray analyzer, measurement is performed under the condition of an accelerating voltage of 20 kV. On the other hand, using a “fluorescent X-ray analyzer XRF-1500” manufactured by Shimadzu Corporation as the fluorescent X-ray analyzer, measurement is performed under the conditions of a tube voltage of 40 kV, a tube current of 90 mA, and a measurement time of 5 minutes.

On the other hand, 1 g of toner is weighed and the toner is placed into a weighed cylindrical filter paper made of glass fiber, and the filter paper is mounted on an extrusion tube of a heating type Soxhlet extractor. Then, toluene is poured into a flask, followed by heating to 110° C. with a mantle heater. In addition, the peripheral portion of the extrusion tube is heated to 125° C. using the heating heater mounted on the extrusion tube. Extrusion is performed at a circulation speed at which the extrusion cycle is 1 cycle in a range of 4 minutes to 5 minutes. After extrusion is performed for 10 hours, the cylindrical filter paper and toner residues are collected, dried, and weighed.

Thereafter, the amount of toner residues (% by weight) is calculated based on an equitation: amount of toner residues (% by weight)=[ (weight of cylindrical filter paper+amount of toner residues) (g)−weight of cylindrical filter paper (g)]/weight of toner (g)×100. The toner residues include inorganic substances such as a brilliant pigment and an external additive, and a toluene insoluble portion. In addition, in the case in which the toner particles include a release agent, the release agent becomes a toluene insoluble portion by performing extrusion under heating.

The amount of the toluene insoluble portion (% by weight) is calculated from the “amount of inorganic substance (brilliant pigment and external additive, in the case in which an external additive is externally added) (% by weight)” determined using a fluorescent X-ray analyzer and the “amount of toner residues (% by weight)” determined using a heating type Soxhlet extractor. That is, the amount of the toluene insoluble portion (% by weight) is calculated by an equation “toluene insoluble portion (% by weight)”=“amount of toner residues (% by weight)”−“amount of inorganic substance (% by weight)”.

Here, the “brilliance” in the toner according to the exemplary embodiment indicates that an image has brilliance similar to metallic luster when the image formed by the brilliant toner is visually checked.

Specifically, when a solid image is formed using the toner according to the exemplary embodiment, it is preferable that a ratio (X/Y) between a reflectance X at a light receiving angle of +30° measured when the image is irradiated with incident light at an incident angle of −45° by a goniophotometer and a reflectance Y at a light receiving angle of −30° is from 2 to 100.

If the ratio (X/Y) is equal to or greater than 2, this indicates that light is reflected more toward a side (“angle+” side) opposite to the light incident side than toward a side (“angle−” side) where the incident light enters, that is, this indicates that diffuse reflection of the incident light is prevented. When the diffuse reflection in which the incident light is reflected to various directions is caused, if the reflected light is visually checked, colors look blurry. Therefore, when the ratio (X/Y) is less than 2, even if the reflected light is visually checked, brilliance is not confirmed, thereby causing inferior brilliant properties in some cases.

On the other hand, when the ratio (X/Y) exceeds 100, a viewing angle in which the reflected light may be visually checked is narrowed too much, and specular reflected light components are large. Therefore, a phenomenon in which colors look darkish depending on angles may occur. In addition, it is also difficult to prepare a toner in which the ratio (X/Y) exceeds 100.

The ratio (X/Y) is more preferably from 4 to 50, still more preferably from 6 to 20, and particularly preferably from 8 to 15 from the viewpoint of brilliance and toner producibility.

Measurement of Ratio (X/Y) by Goniophotometer Here, first, an incident angle and a light receiving angle will be described. In the exemplary embodiment, when the measurement is performed by a goniophotometer, an incident angle is set to −45°. This is because the measuring sensitivity to an image having a wide gloss level is high.

In addition, the reason why the light receiving angles are set to −30° and +30° is that the measuring sensitivity for determining an image with brilliance and an image without brilliance is highest.

Next, the measuring method of the ratio (X/Y) will be described.

An image to be measured (brilliance image) is irradiated with incident light at an incident angle of −45° with respect to the image using a spectro-goniophotometer GC 5000L manufactured by Nippon Denshoku Industries Co., Ltd. as a goniophotometer, and a reflectance X at a light receiving angle of +30° and a reflectance Y at a light receiving angle of −30° are measured. In addition, the reflectance X and the reflectance Y are respectively obtained by performing measurement with light in a wavelength range of 400 nm to 700 nm at intervals of 20 nm and calculating the average value of reflectances of the respective wavelengths. The ratio (X/Y) is calculated from the measurement results.

From the viewpoint of satisfying the ratio (X/Y) described above, the toner according to the exemplary embodiment may preferably meet the requirements (1) and (2) below.

(1) The toner particle has an average equivalent circle diameter D larger than an average maximum thickness C.

(2) When a cross section of the toner particle in a thickness direction thereof is observed, the proportion of brilliant pigment particles arranged so that an angle formed by a long axis direction of the toner particle in the cross section and a long axis direction of the brilliant pigment particle is in a range of −30° to +30° is equal to or greater than 60% of the total number of brilliant pigment particles observed.

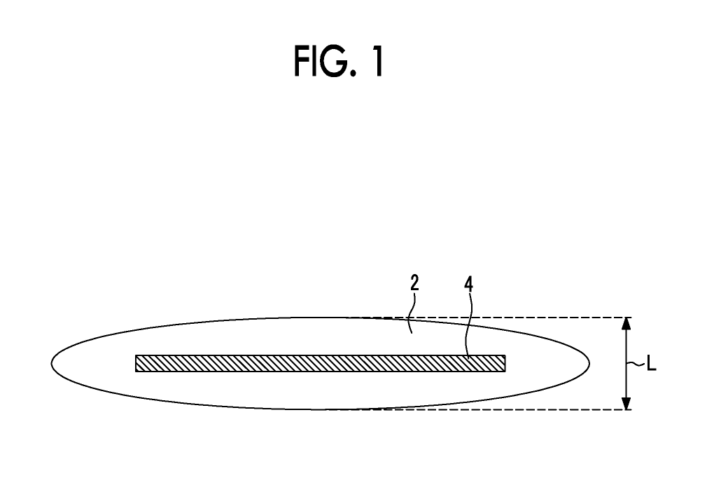

When the toner particles have a flake shape in which the equivalent circle diameter is larger than the thickness (refer to FIG. 1), it is considered that the flake-shaped toner particles are arranged such that the flake surface side of the toner faces a surface of a recording medium by the pressure at the time of fixing in a fixing step for image formation. In FIG. 1, the reference numeral 2 represents a toner particle, the reference numeral 4 represents a brilliant pigment, and the reference symbol L represents the thickness of the toner particle.

Accordingly, among the flake-shaped brilliant pigment particles contained in the toner particles, brilliant pigment particles that satisfy the requirement “an angle formed by a long axis direction of the toner in the cross section and a long axis direction of the brilliant pigment is in a range of −30° to +30°” described in (2) above are considered to be arranged such that the surface side, which provides the maximum area, faces the surface of the recording medium. When an image formed in this manner is irradiated with light, it is considered that the proportion of the brilliant pigment particles, which cause diffuse reflection of incident light, is reduced and thus the above-described range of the ratio (X/Y) may be achieved.

Hereinafter, the toner according to the exemplary embodiment will be described in detail.

The toner according to the exemplary embodiment contains at least a brilliant pigment and a binder resin. The toner according to the exemplary embodiment may contain other additives if necessary.

The toner according to the exemplary embodiment may contain toner particles including a brilliant pigment and a binder resin and an external additive that is externally added to the toner particles.

Toner Particles

The toner particles may contain a brilliant pigment and a binder resin. The toner particles may include other additives, if necessary.

Binder Resin

In the exemplary embodiment, as the binder resin, one or more amorphous resins and one or more crystalline resins may be used in combination. In the exemplary embodiment, when an amorphous resin and a crystalline resin are used in combination as the binder resins, specific examples of the amorphous resin include amorphous polyester resins which will be described later. In addition, specific examples of the crystalline resin include crystalline polyester resins which will be described later.

When a crystalline resin is used as the binder resin, at least one crystalline resin is preferably an aliphatic crystalline resin.

Examples of the aliphatic crystalline resin include aliphatic crystalline polyester resins obtained by a dehydration condensation reaction of aliphatic dicarboxylic acids and aliphatic diols.

Examples of the binder resin include a homopolymer consisting of monomers such as styrenes (for example, styrene, para-chlorostyrene, α-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenically unsaturated nitriles (for example, acrylonitrile, methacrylonitrile, or the like), vinyl ethers (for example, vinyl methyl ether, vinyl isobutyl ether, or the like), vinyl ketones (for example, vinyl methyl ketone, vinyl ethyl ketone, vinyl isopropenyl ketone, or the like), olefins (for example, ethylene, propylene, butadiene, or the like), or a vinyl resin formed of a copolymer obtained by combining two or more kinds of these monomers.

Examples of the binder resin also include a non-vinyl resin such as an epoxy resin, a polyester resin, a polyurethane resin, a polyamide resin, a cellulose resin, a polyether resin, and a modified rosin, a mixture of these and the vinyl resins, or a graft polymer obtained by polymerizing a vinyl monomer in the presence thereof.

These binder resins may be used alone or in combination with two or more kinds thereof.

As the binder resin, a polyester resin is suitable.

As the polyester resin, a well-known amorphous polyester resin is used, for example. As the polyester resin, a crystalline polyester resin may be used in combination together with an amorphous polyester resin. However, the crystalline polyester resin may be used at a content of from 2% by weight to 40% by weight (preferably from 2% by weight to 20% by weight) with respect to the total binder resin.

The term “crystalline” resin indicates that the resin does not exhibit a stepwise change in endothermic quantity but has a clear endothermic peak in differential scanning calorimetry (DSC), and specifically, the “crystalline” resin indicates that the half-value width of an endothermic peak when measured at a temperature rising rate of 10° C./min is within 10° C.

On the other hand, the “amorphous” resin indicates that the half-value width is greater than 10° C., a stepwise change in endothermic quantity is exhibited, or a clear endothermic peak is not recognized.

Amorphous Polyester Resin

Examples of the amorphous polyester resin include polycondensates of polyvalent carboxylic acids and polyols. A commercially available product or a synthesized product may be used as the amorphous polyester resin.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, an ethylene oxide adduct of bisphenol A and a propylene oxide adduct of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with a diol. Examples of the tri- or higher-valent polyol include glycerin, trimethylolpropane, and pentaerythritol.

The polyols may be used alone or in combination of two or more kinds thereof.

The glass transition temperature (Tg) of the amorphous polyester resin is preferably from 50° C. to 80° C., and more preferably from 50° C. to 65° C.

The glass transition temperature is determined by a DSC curve obtained by differential scanning calorimetry (DSC), and more specifically, is determined by “Extrapolated Starting Temperature of Glass Transition” disclosed in a method of determining a glass transition temperature of JIS K-7121-1987 “Testing Methods for Transition Temperature of Plastics”.

The weight average molecular weight (Mw) of the amorphous polyester resin is preferably from 5,000 to 1,000,000, and more preferably from 7,000 to 500,000.

The number average molecular weight (Mn) of the amorphous polyester resin is preferably from 2,000 to 100,000.

The molecular weight distribution Mw/Mn of the amorphous polyester resin is preferably from 1.5 to 100 and more preferably from 2 to 60.

The weight average molecular weight and the number average molecular weight are measured by gel permeation chromatography (GPC). The molecular weight measurement by GPC is performed by using GPC·HLC-8120GPC manufactured by Tosoh Corporation as a measuring device, TSKgel SuperHM-M (15 cm) manufactured by Tosoh Corporation, as a column, and a THF solvent. The weight average molecular weight and the number average molecular weight are calculated using a calibration curve of molecular weight created with a monodisperse polystyrene standard sample from the measurement results.

A polyester resin having a weight average molecular weight of less than 5,000 (preferably an amorphous polyester resin having a weight average molecular weight of less than 5,000) may function as a plasticizer which will be described later.

A known preparing method is applied to prepare the amorphous polyester resin. Specific examples thereof include a method of conducting a reaction at a polymerization temperature set to 180° C. to 230° C., if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with the main component.

Here, examples of the polyester resin also include modified polyester resins other than the aforementioned unmodified polyester resins. The modified polyester resins include a polyester resin in which bonding groups other than an ester bond are present, and a polyester resin in which resin components different from a polyester resin component are bonded by a covalent bond, an ionic bond and the like. Examples of the modified polyester resin include resins in which the end is modified by reaction of a polyester resin into which a functional group such as an isocyanate group reacting with an acid group or a hydroxyl group at the end thereof is introduced, with an active hydrogen compound.

As the modified polyester resin, a urea-modified polyester resin is particularly preferable. When the toner particles include a urea-modified polyester resin as the binder resin, the ratio (Q2/Q1) is easily controlled to be in a range of 0.01 to 0.30. It is considered that this is because the modified polyester resin has an appropriate number of urea-modified groups, compared to an unmodified polyester resin, bias of charge is remarkable and the modified polyester resin is easily mixed with a crystalline resin at the time of fixing melting, thereby preventing recrystallization of the crystalline resin. On the other hand, when the number of urea-modified groups is excessive, steric hindrance becomes larger, the mixability with a crystalline resin is deteriorated, and the crystalline resin and the modified polyester resin are easily separated from each other at the time of cooling after fixing melting, thereby accelerating recrystallization of the crystalline resin. Therefore, it is considered that an appropriate force is applied for recrystallization after fixing melting. From this viewpoint, the content of the urea-modified polyester resin is preferably from 2% by weight to 25% by weight and more preferably from 5% by weight to 20% by weight with respect to the total binder resin.

The urea-modified polyester resin is selected according to the kind and blending amount of monomers used and the like, but one amorphous resin is used in most cases.

The urea-modified polyester resin may be a urea-modified polyester resin obtained by reaction (at least one of a crosslinking reaction and an elongation reaction) between a polyester resin having isocyanate groups (polyester prepolymer) and an amine compound. The urea-modified polyester resin may contain a urethane bond together with a urea bond.

As the polyester prepolymer having isocyanate groups, a prepolymer obtained by reacting a polyester which is a polycondensate of a polyvalent carboxylic acid and a polyol and has active hydrogen with a polyisocyanate compound may be used. Examples of an active hydrogen containing group of the polyester include hydroxyl groups (alcoholic hydroxyl group and phenolic hydroxyl group), an amino group, a carboxyl group, and a mercapto group. The alcoholic hydroxyl group is preferable.

In the polyester prepolymer having isocyanate groups, the polyvalent carboxylic acid and the polyol are compounds similar to the above examples of the polyvalent carboxylic acid and the polyol mentioned in the description of the polyester resin.

Examples of the polyisocyanate compound include aliphatic polyisocyanates (such as tetramethylene diisocyanate, hexamethylene diisocyanate, and 2,6-diisocyanate methylcaproate); alicyclic polyisocyanates (such as isophorone diisocyanate and cyclohexylmethane diisocyanate); aromatic diisocyanates (such as tolylene diisocyanate and diphenylmethane diisocyanate); aromatic aliphatic diisocyanates (such as α,α,α′,α′-tetramethylxylylene diisocyanate); isocyanurates; and compounds formed by blocking the above polyisocyanates with a blocking agent such as a phenol derivative, oxime, caprolactam, or the like.

These polyisocyanate compounds may be used alone or in combination of two or more kinds thereof.

The ratio of the polyvalent isocyanate compound is, in terms of an equivalent ratio [NCO]/[OH] between the isocyanate group [NCO] and the hydroxyl group [OH] of the hydroxyl-containing polyester prepolymer, preferably from 1/1 to 5/1, more preferably from 1.2/1 to 4/1, and still more preferably from 1.5/1 to 2.5/1. When the ratio [NCO]/[OH] is from 1/1 to 5/1, the amount of the toluene insoluble portion is likely to be in the above range, and the ratio (Q2/Q1) is easily controlled to be in a range of 0.01 to 0.30. When the ratio [NCO]/[OH] is 5/1 or less, deterioration of low temperature fixability is easily prevented.

The content of a component derived from the polyvalent isocyanate compound in the polyester prepolymer having isocyanate groups is preferably from 0.5% by weight to 40% by weight, more preferably from 1% by weight to 30% by weight, and still more preferably from 2% by weight to 20% by weight with respect to the total polyester prepolymer having isocyanate groups. When the content of the component derived from the polyvalent isocyanate compound is from 0.5% by weight to 40% by weight, the amount of the toluene insoluble portion is likely to be in the above range and the ratio (Q2/Q1) is easily controlled to be in a range of 0.01 to 0.30. When the content of the component derived from the polyvalent isocyanate compound is 40% by weight or less, deterioration of low temperature fixability is easily prevented.

The average number of isocyanate groups contained per molecule of the polyester prepolymer having isocyanate groups is preferably from 1 or more, more preferably from 1.5 to 3, and still more preferably from 1.8 to 2.5. When the number of isocyanate groups per molecule is 1 or more, the molecular weight of the urea-modified polyester resin after reaction increases, the amount of the toluene insoluble portion is likely to be in the above range, and the ratio (Q2/Q1) is easily controlled to be in a range of 0.01 to 0.30.

Examples of the amine compound reacting with the polyester prepolymer having isocyanate groups include diamines, tri- or higher-valent polyamines, amino alcohols, amino mercaptans, amino acids, and compounds obtained by blocking these amine groups.

Examples of the diamines include aromatic diamines (such as phenylenediamine, diethyltoluenediamine, and 4,4′-diaminodiphenylmethane), alicyclic diamines (such as 4,4′-diamino-3,3′-dimethyldicyclohexylmethane, diaminecyclohexane, and isophoronediamine); and aliphatic diamines (such as ethylenediamine, tetramethylenediamine, and hexamethylenediamine).

Examples of the tri- or higher-valent polyamines include diethylenetriamine and triethylenetetramine.

Examples of amino alcohols include ethanolamine and hydroxyethyl aniline.

Examples of the amino mercaptans include aminoethyl mercaptan and aminopropyl mercaptan.

Examples of the amino acids include aminopropionic acid and aminocaproic acid.

Examples of the compounds obtained by blocking these amine groups include ketimine compounds obtained from amine compounds, such as diamines, tri- or higher-valent polyamines, amino alcohols, amino mercaptans, and amino acids, and ketone compounds (such as acetone, methyl ethyl ketone, and methyl isobutyl ketone) and oxazoline compounds.

Among these amine compounds, the ketimine compounds are preferable.

These amine compounds may be used alone or in combination of two or more kinds thereof.

The molecular weight of the urea-modified polyester resin after completion of the reaction may be adjusted by adjusting reaction between the polyester resin having isocyanate groups (polyester prepolymer) and the amine compound (at least one of a crosslinking reaction and an elongation reaction) with a reaction terminator which terminates at least one of a crosslinking reaction and an elongation reaction (hereinafter, also referred to as “crosslinking/elongation reaction terminator”).

Examples of the crosslinking/elongation reaction terminator include monoamines (such as diethylamine, dibutylamine, butylamine, and laurylamine) and blocked compounds thereof (ketimine compounds).

The ratio of the amine compound is, in terms of an equivalent ratio [NCO]/[NHx] between the isocyanate group [NCO] in the polyester prepolymer having isocyanate groups and the amino group [NHx] in the amines, preferably from 1/2 to 2/1, more preferably from 1/1.5 to 1.5/1, and still more preferably from 1/1.2 to 1.2/1. When the [NCO]/[NHx] is in the above range, the molecular weight of the urea-modified polyester resin after reaction increases, the amount of the toluene insoluble portion is likely to be in the above range, and the ratio (Q2/Q1) is easily controlled to be in a range of 0.01 to 0.30.

The glass transition temperature of the urea-modified polyester resin is preferably from 40° C. to 65° C. and more preferably from 45° C. to 60° C. The number average molecular weight thereof is preferably from 2,500 to 50,000 and more preferably from 2,500 to 30,000. The weight average molecular weight is preferably from 10,000 to 500,000 and more preferably from 30,000 to 100,000.

Crystalline Polyester Resin

Examples of the crystalline polyester resin include polycondensates of polyvalent carboxylic acids and polyols. A commercially available product or a synthesized product may be used as the crystalline polyester resin.

Here, as the crystalline polyester resin, in order to easily form a crystal structure, a polycondensate using a polymerizable monomer having a linear aliphatic group is preferably used rather than a polymerizable monomer having an aromatic group.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylicacid, 1,12-dodecanedicarboxylicacid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, naphthalene-2,6-dicarboxylic acid), anhydrides thereof, or lower alkyl esters (having, for example, from 1 to 5 carbon atoms) thereof.

As the polyvalent carboxylic acid, a tri- or higher-valent carboxylic acid having a crosslinked structure or a branched structure may be used in combination together with a dicarboxylic acid. Examples of the trivalent carboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, or lower alkyl esters (having, for example, from 1 to 5 carbon atoms) thereof.

As the polyvalent carboxylic acid, a dicarboxylic acid having a sulfonic acid group or a dicarboxylic acid having an ethylenic double bond may be used in combination together with these dicarboxylic acids.

The polyvalent carboxylic acids may be used alone or in combination of two or more kinds thereof.

Examples of the polyol include aliphatic diols (for example, linear aliphatic diols having from 7 to 20 carbon atoms in a main chain portion). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these, 1,8-octanediol, 1,9-nonanediol, and 1,10-decanediol are preferable as the aliphatic diol.

As the polyol, a tri- or higher-valent polyol having a crosslinked structure or a branched structure may be used in combination together with a diol. Examples of the tri- or higher-valent polyol include glycerin, trimethylolethane, trimethylolpropane, and pentaerythritol.

The polyols may be used alone or in combination of two or more kinds thereof.

Here, in the polyol, the content of the aliphatic diol may be 80% by mole or more, and is preferably 90% by mole or more.

When an aliphatic crystalline resin is used as the binder resin in the exemplary embodiment, the aliphatic crystalline resin is preferably an aliphatic crystalline polyester resin including a constituent unit derived from an aliphatic diol (hereinafter referred to as “aliphatic diol-derived constituent unit”) having a carbon chain length of 2 to 20 and a constituent unit derived from an aliphatic dicarboxylic acid (hereinafter referred to as “aliphatic dicarboxylic acid-derived constituent unit”) having a carbon chain length of 2 to 20. The term “carbon chain length” as used herein means the number of carbon atoms constitute the carbon chain. In the aliphatic crystalline polyester resin, the carbon chain length of the aliphatic diol as a group of the aliphatic diol-derived constituent unit is more preferably from 4 to 20, and the carbon chain length of the aliphatic dicarboxylic acid as a group of the aliphatic dicarboxylic acid-derived constituent unit is more preferably from 6 to 20. The carbon chain length of the aliphatic diol as a group of the aliphatic diol-derived constituent unit is still more preferably from 4 to 12, and the carbon chain length of the aliphatic dicarboxylic acid as a group of the aliphatic dicarboxylic acid-derived constituent unit is still more preferably from 6 to 14.

An aliphatic crystalline polyester resin in which the total of the carbon chain length of the aliphatic diol-derived constituent unit and the carbon chain length of the aliphatic dicarboxylic acid-derived constituent unit is from 2 to 10 may function as a plasticizer which will be described later.

In addition, an aliphatic crystalline polyester resin in which the total of the carbon chain length of the aliphatic diol-derived constituent unit and the carbon chain length of the aliphatic dicarboxylic acid-derived constituent unit is 22 or more may function as a nucleating agent, which will be described later. In the aliphatic crystalline polyester resin which functions as a nucleating agent, the total of the carbon chain length of the aliphatic diol-derived constituent unit and the carbon chain length of the aliphatic dicarboxylic acid-derived constituent unit is preferably 40 or less and more preferably 30 or less.

In the exemplary embodiment, the carbon chain length included in the diol refers to the total number of a first carbon atom to which one of two hydroxyl groups is bonded, a second carbon atom to which the other hydroxyl group is bonded, and a carbon atom included as an element constituting a linear skeleton between the first carbon atom and the second carbon atom. For example, the carbon chain length of 1,8-octanediol is 8, the carbon chain length of 1,9-nonanediol is 9, and the carbon chain length of nonane-1,8-diol is 8.

In the exemplary embodiment, the carbon chain length included in the aliphatic dicarboxylic acid refers to the total number of a first carbon atom to which one of two carboxyl groups is bonded, a second carbon atom to which the other carboxyl group is bonded, and a carbon atom included as an element constituting a linear skeleton between the first carbon atom and the second carbon atom. For example, the carbon chain length of 1,9-nonanedicarboxylic acid is 9, the carbon chain length of 1,10-decanedicarboxylic acid is 10, and the carbon chain length of nonane-1,8-dicarboxylic acid is 8.

In addition, in the exemplary embodiment, the total carbon chain length of the crystalline resin refers to a value of the total of each unit of the carbon chain length of the diol component and the carbon chain length of the dicarboxylic acid component.

The melting temperature of the crystalline polyester resin is preferably from 50° C. to 100° C., more preferably from 55° C. to 90° C., and still more preferably from 60° C. to 85° C.

The melting temperature is obtained from “melting peak temperature” described in the method of obtaining a melting temperature in JIS K 7121-1987 “testing methods for transition temperatures of plastics”, from a DSC curve obtained by differential scanning calorimetry (DSC) measurement.

The weight average molecular weight (Mw) of the crystalline polyester resin is preferably from 6,000 to 35,000.

A known preparing method is applied to prepare the crystalline polyester resin as in the case of the amorphous polyester resin.

When an amorphous resin and a crystalline resin are used in combination as the binder resins, an absolute value ΔSP of a difference between the solubility parameter (SP value) of the crystalline resin and the SP value of the amorphous resin is preferably from 0.1 to 0.7, more preferably from 0.2 to 0.7, and still more preferably from 0.2 to 0.6.

When the ΔSP is from 0.1 to 0.7, the ratio (Q2/Q1) is easily controlled to be in a range of 0.01 to 0.30.

When two or more amorphous resins are used in combination, the SP value of the amorphous resins refers to the SP value of a mixture of the two or more amorphous resins. In the same manner, when two or more crystalline resins are used in combination, the SP value of the crystalline resin refers to the SP value of a mixture of the two or more crystalline resins.

There are various methods for calculating the SP value, such as the Small method and the Fedors method. A value obtained by the Fedors method is adopted as the SP value herein.

In this case, the SP value is defined by the following equation (1).

$$SP = \sqrt{\frac{Δ E}{V}} = \sqrt{\frac{{\sum }_{i} Δ ei}{{\sum }_{i} Δ vi}} \qquad Equation ( 1 )$$

In the equation (1), SP represents the solubility parameter, ΔE represents the aggregation energy (cal/mol), V represents the mole volume (cm³/mol), Δei represents the evaporation energy of the i-th atom or atomic group (cal/atom or atomic group), Δvi represents the mole volume of the i-th atom or atomic group (cm³/atom or atomic group), and i represents an integer of 1 or more.

The SP value represented by the equation (1) is calculated so as to have [cal^{1/2}/cm^{3/2}] as its unit by practice, and it is represented by no dimension. Additionally, in the exemplary embodiment, since the relative difference of the SP values between the two compounds is meaningful, a value calculated according to the above-mentioned practice is used and represented by no dimension in the exemplary embodiment.

For reference, in the case the SP value represented by the equation (1) is converted to the SI unit (J^{1/2}/m^{3/2}), the value is multiplied by 2046.

The content of the binder resin is, for example, preferably from 40% by weight to 95% by weight, more preferably from 50% by weight to 90% by weight, and still more preferably from 60% by weight to 85% by weight with respect to the total toner particles.

Brilliant Pigment

As the brilliant pigment, for example, a pigment (brilliant pigment) that may provide brilliance similar to metallic luster may be used. Specific examples of the brilliant pigment include metal powders such as aluminum (Al element metal), brass, bronze, nickel, stainless steel, and zinc powders; coated foil-shaped inorganic crystalline substrates, such as mica, barium sulfate, layered silicate and layered aluminum silicate coated with titanium oxide or yellow iron oxide; single-crystal planar titanium oxide; basic carbonates; acid bismuth oxychloride; natural guanine; foil-shaped glass powder; and metal-deposited foil-shaped glass powder. The brilliant pigment is not particularly limited as long as the pigment has brilliance.

Among the brilliant pigments, from the viewpoint of mirror surface reflection intensity, metal powders are preferable and among these, aluminum is most preferable.

The brilliant pigment preferably has a flake shape.

The average length of the brilliant pigment in a long axis direction is preferably from 1 μm to 20 μm, more preferably from 3 μm to 20 μm, and still more preferably from 5 μm to 15 μm.

When the average length of the brilliant pigment in the long axis direction is 1 μm or more, the brilliance of a toner image is easily obtained. When the average length of the brilliant pigment in the long axis direction is 20 μm or less, the dielectric properties of toner is prevented from being deteriorated and an image is prevented from being damaged at the time of transfer.

The ratio (aspect ratio) of the average length in the long axis direction to the average length in the thickness direction with respect to the brilliant pigment (that is, the average length in the thickness direction is taken as 1), is preferably from 5 to 200, more preferably from 10 to 100, and still more preferably 30 to 70.

The respective average lengths and the aspect ratio of the brilliant pigment are measured by the following method. A photograph of the pigment particles is captured by using a scanning electron microscope (S-4800, manufactured by Hitachi High Technologies Co., Ltd.), with measurable magnification power (from 300 times to 100,000 times), the length of each particle in the long axis direction and the length thereof in a thickness direction are measured in a two-dimensional state of the obtained image of the pigment particle, and the average length in the long axis direction and the aspect ratio of the brilliant pigment are calculated.

The content of the brilliant pigment is preferably from 1 part by weight to 50 parts by weight and more preferably from 15 parts by weight to 30 parts by weight, with respect to 100 parts by weight of the toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

The melting temperature of the release agent is preferably from 50° C. to 110° C., and more preferably from 60° C. to 100° C.

The melting temperature is obtained from “melting peak temperature” described in the method of obtaining a melting temperature in JIS K 7121-1987 “Testing methods for transition temperatures of plastics”, from a DSC curve obtained by differential scanning calorimetry (DSC).

The content of the release agent is, for example, preferably from 1% by weight to 20% by weight, and more preferably from 5% by weight to 15% by weight with respect to the total toner particles.

Other Additives

Examples of other additives include known additives such as a plasticizer, a nucleating agent, a magnetic material, a charge-controlling agent, an inorganic particle and coloring agents other than the brilliant pigment. The toner particles include these additives as internal additives.

As the plasticizer, at least one selected from the group consisting of phthalic acid ester, isophthalic acid ester, trimellitic acid ester, adipic acid ester, phosphoric acid ester, palmitic acid ester, a polyester resin having a weight average molecular weight of less than 5,000, and a liquid paraffin is preferably used and ester compounds are more preferably used.

In the exemplary embodiment, specific examples of the phthalic acid ester include dibutyl phthalate, and bis (2-ethylhexyl) phthalate.

In the exemplary embodiment, specific examples of the isophthalic acid ester include dibutyl isophthalate, and bis (2-ethylhexyl) isophthalate.

In the exemplary embodiment, specific examples of the trimellitic acid ester include dibutyl trimellitate.

In the exemplary embodiment, specific examples of the adipic acid ester include bis (2-ethylhexyl) adipate.

In the exemplary embodiment, specific examples of the phosphoric acid ester include tributyl phosphate.

In the exemplary embodiment, specific examples of the palmitic acid ester include tripalmitin.

As the nucleating agent, at least one selected from the group consisting of metal salts of benzoic acid, metal salts of stearic acid, metal salts of phosphoric acid ester, metal salts of oxalic acid, sorbitol compounds, carbon black, metal oxides, kaolin, and talc is preferably used and metal salt compounds are preferably used.

In the exemplary embodiment, specific examples of the metal salts of benzoic acid include sodium benzoate.

In the exemplary embodiment, specific examples of the metal salts of stearic acid include sodium stearate.

In the exemplary embodiment, specific examples of the metal salts of phosphoric acid ester include sodium bis (4-tert-butyl-phenyl) phosphate.

In the exemplary embodiment, specific examples of the metal salts of oxalic acid include calcium oxalate.

In the exemplary embodiment, specific examples of the sorbitol compounds include dibenzylidene sorbitol.

In the exemplary embodiment, specific examples of the metal oxides include silica.

Examples of the charge-controlling agent include quaternary ammonium salt compounds, nigrosine compounds, dyes containing a complex of aluminum, iron, chromium, or the like, and triphenylmethane pigments.

Examples of the inorganic particles include known inorganic particles such as silica particles, titanium oxide particles, alumina particles, cerium oxide particles, and particles obtained by hydrophobizing the surfaces of these particles. These inorganic particles may be used alone or in combinations of two or more kinds thereof. Among these inorganic particles, silica particles, which have a refractive index lower than that of the above-described binder resin, are preferably used. The silica particles may be subjected to various surface treatments. For example, silica particles surface-treated with a silane coupling agent, a titanium coupling agent, a silicone oil, or the like are preferably used.

Characteristics of Toner Particles

The toner particles may be toner particles having a single layer structure, or toner particles having a so-called core/shell structure composed of a core (core particle) and a coating layer (shell layer) coated on the core.

The toner particles having a core/shell structure may be composed of, for example, a core containing a binder resin, a brilliant pigment, and if necessary, other additives, and a coating layer containing a binder resin.

Average Maximum Thickness C and Average Equivalent Circle Diameter D of Toner Particles

The toner particles have a flake shape and the average equivalent circle diameter D is preferably longer than the average maximum thickness C. In addition, the ratio (C/D) of the average maximum thickness C to the average equivalent circle diameter D is more preferably in a range of 0.001 to 0.500, still more preferably in a range of 0.010 to 0.200, and particularly preferably in a range of 0.050 to 0.100.

When the ratio (C/D) is 0.001 or more, toner strength is ensured and fracturing that is caused by a stress in the image formation is prevented, and thus a reduction in charges that is caused by exposure of the pigment, and fogging that is caused as a result thereof are prevented. On the other hand, when the ratio (C/D) is 0.500 or less, excellent brilliance is obtained.

The average maximum thickness C and the average equivalent circle diameter D are measured by the methods below.

Toner particles are placed on a smooth surface and uniformly dispersed by applying vibrations. One thousand toner particles are observed with a color laser microscope “VK-9700” (manufactured by Keyence Corporation) at a magnification of 1,000 times to measure the maximum thickness C and the equivalent circle diameter D of a surface viewed from the top in the brilliant toner particles, and the arithmetic averages thereof are calculated to determine the average maximum thickness C and the average equivalent circle diameter D.

Angle Formed by Long Axis Direction of Toner Particle in Cross Section and Long Axis Direction of Brilliant Pigment Particles

When a cross section of a toner particle in the thickness direction thereof is observed, the proportion (based on number) of brilliant pigment particles arranged so that an angle formed by a long axis direction of the toner particle in the cross section and a long axis direction of a brilliant pigment particle is in the range of −30° to +30° is preferably 60% or more of the total number of brilliant pigment particles observed. Furthermore, the number is more preferably from 70% to 95%, and particularly preferably from 80% to 90%.

When the above number is 60% or more, a good brilliance may be obtained.

Here, a method of observing the cross section of the toner particles will be described.

Toner particles are embedded in a mixture of a bisphenol A-type liquid epoxy resin and a curing agent to prepare a sample for cutting. Next, the sample for cutting is cut at −100° C. using a cutting machine with a diamond knife, (for example, using an ultramicrotome (Ultracut UCT, manufactured by Leica Microsystems)) to prepare a sample for observation. The sample for observation is observed using an ultrahigh resolution field emission scanning electron microscope (S-4800, manufactured by Hitachi High Technologies Co., Ltd.) with magnification power with which about 1 to 10 toner particles are observed in one view field.

Specifically, the cross section of the toner particles (the cross section of the toner particles in the thickness direction) is observed and regarding the observed 100 toner particles, the number of brilliant pigment particles arranged so that an angle formed by the long axis direction of the toner particles in the cross section and the long axis direction of the brilliant pigment is in a range of −30° to +30° is counted by using, for example, image analysis software (WinROOF) manufactured by Mitani Corporation or using an output sample of the observed image and a protractor and the ratio thereof is calculated.

The term “long axis direction of toner particle in the cross section” refers to a direction orthogonal to a thickness direction of toner particle having an average equivalent-circle diameter D larger than the average maximum thickness C, and the term “long axis direction of a brilliant pigment particle” refers to a length direction of the brilliant pigment particle.

The volume average particle diameter of the toner particles according to the exemplary embodiment is preferably from 1 μm to 30 μm, and more preferably from 3 μm to 20 μm.

The volume average particle diameter D₅₀ᵥ of the toner particles is determined as follows. A cumulative volume distribution curve and a cumulative number distribution curve are drawn from the smaller particle diameter end, respectively, for each particle diameter range (channel) divided on the basis of a particle diameter distribution measured with a measuring instrument such as a Multisizer II (manufactured by Beckman Coulter Inc.). The particle diameter providing 16% accumulation is defined as that corresponding to volume D₁₆ᵥ and number D₁₆ₚ, the particle diameter providing 50% accumulation is defined as that corresponding to volume D₅₀ᵥ and number D₅₀ₚ, and the particle diameter providing 84% accumulation is defined as that corresponding to volume D₈₄ᵥ and number D₈₄ₚ. The volume average particle diameter distribution index (GSDv) is calculated as (D₈₄ᵥ/D₁₆ᵥ)^{1/2} using these values.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO—SiO₂, K₂O (TiO₂) n, Al₂O₃.2SiO₂, CaCO₃, MgCO₃, BaSO₄, and MgSO₄.

The surfaces of the inorganic particles used as the external additive may be treated with a hydrophobizing agent. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

Examples of the external additive also include resin particles (resin particles such as polystyrene, polymethyl methacrylate (PMMA), and melamine resin) and a cleaning aid (for example, metal salt of higher fatty acid represented by zinc stearate, and fluorine polymer particles).

The amount of the external additive externally added is, for example, preferably from 0.01% by weight to 10% by weight and more preferably from 0.5% by weight to 6.0% by weight, with respect to the toner particles.

Toner Preparing Method

Next, a method of preparing a toner according to the exemplary embodiment will be described.

The toner according to the exemplary embodiment is obtained by externally adding an external additive to toner particles after preparing the toner particles including the brilliant pigment.

The toner particles may be prepared using any of a dry method, for example, a kneading and pulverizing method and a wet method, for example, an aggregation and coalescence method, a suspension and polymerization method, and a dissolution and suspension method. The toner particle preparing method is not particularly limited to these processes, and a known process is employed.

For example, the dissolution and suspension method is a method of obtaining toner particles by granulation including:

dispersing a liquid, formed by dissolving or dispersing materials constituting toner particles (such as resin particles and a brilliant pigment) in an organic solvent in which a binder resin is soluble, in an aqueous solvent containing a particle dispersant, and then removing the organic solvent.

In addition, an aggregating and coalescence method is a method of obtaining toner particles through an aggregation step of forming aggregates of materials constituting toner particles (such as resin particles and a brilliant pigment), and a coalescence step of coalescing the aggregates.

Among these, toner particles including a urea-modified polyester resin as the binder resin may be obtained by the following dissolution and suspension method. In the following description of the dissolution and suspension method, a method of obtaining toner particles including an unmodified polyester resin and a urea-modified polyester resin as the binder resins is described. However, the toner particles may include only the urea-modified polyester resin as the binder resin.

Oil Phase Liquid Preparation Step

An oil phase liquid obtained by dissolving or dispersing toner particle materials including an unmodified polyester resin, a polyester prepolymer having isocyanate groups, an amine compound, a brilliant pigment, and a release agent in an organic solvent is prepared (oil phase liquid preparation step). The oil phase liquid preparation step is a step of obtaining a mixed solution of the toner material by dissolving or dispersing the toner particle materials in the organic solvent.

The oil phase liquid may be prepared by methods such as 1) a preparation method of collectively dissolving or dispersing toner materials in an organic solvent, 2) a preparation method of kneading toner materials in advance, and then dissolving or dispersing the kneaded material in an organic solvent, 3) a preparation method of dissolving an unmodified polyester resin, a polyester prepolymer having isocyanate groups, and an amine compound in an organic solvent, and then dispersing a brilliant pigment, and a release agent in the organic solvent, 4) a preparation method of dispersing a brilliant pigment, and a release agent in an organic solvent, and then dissolving an unmodified polyester resin, a polyester prepolymer having isocyanate groups, and an amine compound in the organic solvent, 5) a preparation method of dissolving or dispersing toner particle materials (an unmodified polyester resin, a brilliant pigment, and a release agent), other than a polyester prepolymer having isocyanate groups and an amine compound, in an organic solvent, and then dissolving the polyester prepolymer having isocyanate groups and the amine compound in the organic solvent, and 6) a preparation method of dissolving or dispersing toner particle materials (an unmodified polyester resin, a brilliant pigment, and a release agent), other than a polyester prepolymer having isocyanate groups or an amine compound, in an organic solvent, and then dissolving the polyester prepolymer having isocyanate groups or the amine compound in the organic solvent. The method of preparing the oil phase liquid is not limited thereto.

Examples of the organic solvent of the oil phase liquid include ester solvents such as methyl acetate and ethyl acetate; ketone solvents such as methyl ethyl ketone and methyl isopropyl ketone; aliphatic hydrocarbon solvents such as hexane and cyclohexane, and halogenated hydrocarbon solvents such as dichloromethane, chloroform, and trichloroethylene. These organic solvents are preferably capable of dissolving therein the binder resin, preferably have a water solubility of about from 0% by weight to 30% by weight, and have a boiling temperature of 100° C. or lower. Among these organic solvents, ethyl acetate is preferable.

Suspension Preparation Step

Next, the obtained oil phase liquid is dispersed in a water phase liquid to prepare a suspension (suspension preparation step).

Reaction between the polyester prepolymer having isocyanate groups and the amine compound is conducted with preparation of the suspension. Then, a urea-modified polyester resin is formed by the reaction. This reaction accompanies at least one of crosslinking reaction and elongation reaction in a molecular chain. The reaction between the polyester prepolymer having isocyanate groups and the amine compound may be conducted with an organic solvent removal step, which will be described later.

Here, the reaction conditions are selected according to reactivity between the isocyanate group structure of the polyester prepolymer and the amine compound. For example, the reaction time is preferably from 10 minutes to 40 hours and more preferably from 2 hours to 24 hours. The reaction temperature is preferably from 0° C. to 150° C. and more preferably from 40° C. to 98° C. For the formation of the urea-modified polyester resin, if necessary, known catalyst (such as dibutyltin laurate and dioctyltin laurate) may be used. That is, a catalyst may be added to the oil phase liquid or the suspension.

Examples of the water phase liquid include water phase liquids in which a particle dispersant such as an organic particle dispersant or an inorganic particle dispersant is dispersed in an aqueous solvent. Examples of the water phase liquid also include water phase liquids in which a particle dispersant is dispersed in an aqueous solvent and a polymer dispersant is dispersed in the aqueous solvent. Known additives such as a surfactant may be added to the water phase liquid.

The aqueous solvent may be water (for example, generally, ion exchange water, distilled water, and pure water). The aqueous solvent may be a solvent including an organic solvent such as alcohols (such as methanol, isopropyl alcohol, and ethylene glycol), dimethylformamide, tetrahydrofuran, cellosolves (such as methyl cellosolve), or lower ketones (such as acetone, and methyl ethyl ketone), together with water.

Examples of the organic particle dispersant include hydrophilic organic particle dispersants. Examples of the organic particle dispersant include particles of alkyl poly(meth)acrylate resin (for example, polymethyl methacrylate resin), and polystyrene resin, poly(styrene-acrylonitrile) resin. Examples of the organic particle dispersant also include particles of styrene acrylic resin.

Examples of the inorganic particle dispersant include hydrophilic inorganic particle dispersants. Specific examples of the inorganic particle dispersant include particles of silica, alumina, titania, calcium carbonate, magnesium carbonate, tricalcium phosphate, clay, diatomaceous earth, and bentonite and particles of calcium carbonate are preferable. The inorganic particle dispersants may be used alone or in combination of two or more kinds thereof.

The particle dispersant may be surface-treated with a polymer having a carboxyl group.

Examples of the polymer having a carboxyl group include copolymers between an α,β-monoethylenically unsaturated carboxylic acid or at least one selected from salts (such as alkali metal salts, alkaline earth metal salts, ammonium salts, and amine salts) obtained by neutralizing the carboxyl group of an α,β-monoethylenically unsaturated carboxylic acid with an alkali metal, an alkaline earth metal, ammonium or amine, and an α,β-monoethylenically unsaturated carboxylic ester. Examples of the polymer having a carboxyl group also include salts (such as alkali metal salts, alkaline earth metal salts, ammonium salts and amine salts) obtained by neutralizing the carboxyl group of a copolymer between an α,β-monoethylenically unsaturated carboxylic acid and an α,β-monoethylenically unsaturated carboxylate ester with an alkali metal, an alkaline earth metal, ammonium or amine. The polymers having a carboxyl group may be used alone or in combination of two or more kinds thereof.

Representative examples of the α,β-monoethylenically unsaturated carboxylic acid include α,β-unsaturated monocarboxylic acids (such as acrylic acid, methacrylic acid, and crotonic acid), and α,β-unsaturated dicarboxylic acids (such as maleic acid, fumaric acid, and itaconic acid). In addition, representative examples of the α,β-monoethylenically unsaturated carboxylic ester include alkyl esters of (meth)acrylic acid, (meth)acrylates having an alkoxy group, (meth)acrylates having a cyclohexyl group, (meth)acrylates having a hydroxy group, and polyalkylene glycol mono(meth)acrylates.

Examples of the polymer dispersant include hydrophilic polymer dispersants. Specific examples of the polymer dispersant include polymer dispersants having a carboxyl group and not having a lipophilic group (such as a hydroxypropoxy group or a methoxy group) (for example, water-soluble cellulose esters such as carboxymethyl cellulose, and carboxyethyl cellulose).

Solvent Removal Step

Next, a toner particle dispersion is obtained by removing the organic solvent from the obtained suspension (solvent removal step). In the solvent removal step, toner particles are formed by removing the organic solvent included in the liquid droplets of the water phase liquid dispersed in the suspension. The organic solvent removal from the suspension may be performed immediately after the suspension preparation step, but may be performed when at least one minute has passed after the completion of the suspension preparation step.

In the solvent removal step, the organic solvent may be removed from the suspension by cooling or heating the obtained suspension to, for example, a range of 0° C. to 100° C.

As a specific method of removing the organic solvent, the following methods may be used.

(1) A method in which air is blown into the suspension to forcibly renew the gas phase on the surface of the suspension. In this case, a gas may be blown into the suspension.

(2) A method in which the pressure is reduced. In this case, the gas phase on the surface of the suspension may be forcibly renewed by purging with a gas or moreover, a gas may be blown into the suspension.

Toner particles are obtained through the above steps.

Here, after the completion of the solvent removal step, toner particles formed in the toner particle dispersion are subjected to known steps including a washing step, a solid-liquid separation step, and a drying step and thus dry toner particles are obtained.

The washing step may be performed by sufficient substitution and washing with ion exchange water from the viewpoint of charging properties.

In addition, the solid-liquid separation step is not particularly limited and suction filtration, pressure filtration, and the like may be performed from the viewpoint of productivity. In addition, the drying step is not particularly limited and from the viewpoint of productivity, freeze-drying, flush-jet drying, fluidized drying, or vibrating fluidized drying may be performed.

Then, the toner according to the exemplary embodiment may be prepared by adding an external additive to the obtained dry toner particles and mixing the materials.

The mixing may be performed by using a V blender, a Henschel mixer, a ready-gel mixer, and the like.

Further, if necessary, coarse toner particles may be removed by using a vibration classifier, a wind classifier, and the like.

In the kneading and pulverizing method, respective materials such as a brilliant pigment are mixed and the materials are then molten-kneaded with a kneader, an extruder, and the like. The obtained molten-kneaded material is coarsely pulverized and finely pulverized with a jet mill or the like, followed by classification with a wind classifier. As a result, toner particles having a desired particle diameter are obtained.

More specifically, the kneading and pulverizing method is divided into a kneading step of kneading a toner forming material including a brilliant pigment and a binder resin, and a pulverizing step of pulverizing the kneaded material. The kneading and pulverizing method may have other steps of a cooling step of cooling the kneaded material formed in the kneading step, if necessary.

The respective steps of the kneading and pulverizing method will be described in detail.

Kneading Step

In the kneading step, a toner forming material containing a brilliant pigment and a binder resin is kneaded.

In the kneading step, from 0.5 parts by weight to 5 parts by weight of an aqueous medium (for example, water such as distilled water or ion exchange water, alcohols, or the like) is preferably added with respect to 100 parts by weight of the toner forming material.

Examples of a kneader that is used in the kneading step include a single-screw extruder and a twin-screw extruder. Hereinafter, as an example of the kneader, a kneader having a sending screw portion and two kneading portions will be described using a diagram, but the example of the kneader is not limited thereto.

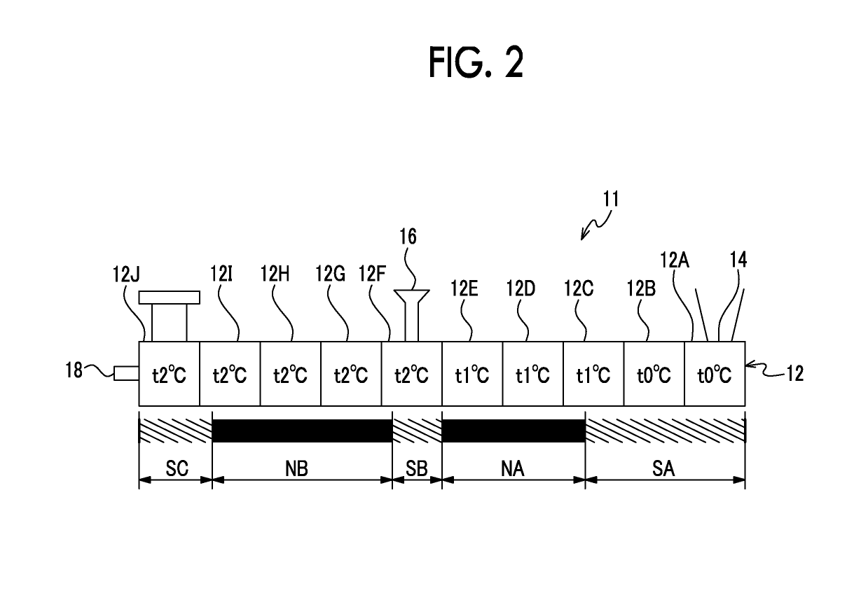

FIG. 2 is a view for explaining the state of a screw of an example of a screw extruder that is used in the kneading step of the method of preparing the toner according to the exemplary embodiment.

A screw extruder 11 is constituted by a barrel 12 provided with a screw (not shown), an injection port 14 through which a toner forming material that is a raw material of the toner is injected to the barrel 12, a liquid addition port 16 for adding an aqueous medium to the toner forming material in the barrel 12, and a discharge port 18 through which the kneaded material formed by kneading the toner forming material in the barrel 12 is discharged.

The barrel 12 is divided into, in ascending order of distance from the injection port 14, a sending screw portion SA that transports a toner forming material injected from the injection port 14 to a kneading portion NA, the kneading portion NA for melting and kneading the toner forming material through a first kneading step, a sending screw portion SB that transports the toner forming material molten-kneaded in the kneading portion NA to a kneading portion NB, the kneading portion NB that melts and kneads the toner forming material through a second kneading step to form a kneaded material, and a sending screw portion SC that transports the formed kneaded material to the discharge port 18.

In addition, in the barrel 12, a different temperature controller (not shown) is provided for each block. That is, the temperatures of blocks 12A to 12J may be controlled to be different from each other. FIG. 2 shows a state in which the temperatures of the blocks 12A and 12B are controlled to t0° C., the temperatures of the blocks 12C to 12E are controlled to t1° C., and the temperatures of the blocks 12F to 12J are controlled to t2° C. Therefore, the toner forming material in the kneading portion NA is heated to t1° C., and the toner forming material in the kneading portion NB is heated to t2° C.

When the toner forming material including a binder resin, a brilliant pigment, and if necessary, a release agent and the like is supplied to the barrel 12 from the injection port 14, the sending screw portion SA sends the toner forming material to the kneading portion NA. At this time, since the temperature of the block 12C is set to t1° C., the toner forming material melted by heating is tranported to the kneading portion NA. In addition, since the temperatures of the blocks 12D and 12E are also set to t1° C., the toner forming material is molten-kneaded at a temperature of t1° C. in the kneading portion NA. The binder resin and the release agent are melted in the kneading portion NA and subjected to shear by the screw.

Next, the toner forming material kneaded in the kneading portion NA is sent to the kneading portion NB by the sending screw portion SB.

In the sending screw portion SB, an aqueous medium is added to the toner forming material by injecting the aqueous medium to the barrel 12 from the liquid addition port 16. In FIG. 2, the aqueous medium is injected in the sending screw portion SB, but the invention is not limited thereto. The aqueous medium may be injected in the kneading portion NB, or may be injected in both of the sending screw portion SB and the kneading portion NB. That is, the position at which the aqueous medium is injected and the place of injection are selected as necessary.

As described above, due to the injection of the aqueous medium to the barrel 12 from the liquid addition port 16, the toner forming material in the barrel 12 and the aqueous medium are mixed, and the toner forming material is cooled by evaporative latent heat of the aqueous medium, whereby the temperature of the toner forming material is maintained.

Finally, the kneaded material formed by melting and kneading by the kneading portion NB is transported to the discharge port 18 by the sending screw portion SC, and is discharged from the discharge port 18.

The kneading step using the screw extruder 11 shown in FIG. 2 is performed as described above.

Cooling Step

The cooling step is a step of cooling the kneaded material that is formed in the kneading step, and in the cooling step, the kneaded material is preferably cooled to 40° C. or lower from the temperature of the kneaded material upon the end of the kneading step at an average temperature falling rate of 4° C./sec or higher. In some cases, when the cooling rate of the kneaded material is low, the mixture (mixture with the brilliant pigment, and if necessary, an internal additive such as a release agent to be internally added into toner particles) finely dispersed in the binder resin in the kneading step is recrystallized and the dispersion diameter increases. Since the dispersion state immediately after the end of the kneading step is maintained as it is, the kneaded material is preferably rapidly cooled at the average temperature falling rate. The average temperature falling rate is an average value of the rate at which the temperature is decreased to 40° C. from the temperature of the kneaded material upon the end of the kneading step (for example, t2° C. when the screw extruder 11 of FIG. 2 is used).

Specific examples of the cooling method in the cooling step include a method using a mill roll with cold water or brine circulated therein and a method using an insertion-type cooling belt. When the cooling is performed using the above-described method, the cooling rate is determined by the speed of the mill roll, the flow rate of the brine, the supply amount of the kneaded material, the slab thickness at the time of rolling of the kneaded material, and the like. The slab thickness is preferably from 1 mm to 3 mm.

Pulverizing Step

The kneaded material cooled through the cooling step is pulverized through the pulverizing step to form toner particles. In the pulverizing step, for example, a mechanical pulverizer, a jet pulverizer or the like is used.

Classification Step

If necessary, the toner particles obtained through the pulverizing step may be classified through a classification step in order to obtain toner particles having a volume average particle size in a target range. In the classification step, a centrifugal classifier, an inertia-type classifier or the like, that have been used in the related art, is used, and fine particles (toner particles having a particle size smaller than the target range) and coarse particles (toner particles having a particle size larger than the target range) are removed.

External Addition Step

For the purpose of adjusting charge, imparting fluidity, imparting charge exchangeability, and the like, inorganic particles represented by silica, titania and aluminum oxide may be added and attached to the obtained toner particles. This is performed by, for example, a V blender, a Henschel mixer, a Loedige mixer or the like, and the attachment may be performed in stages. The amount the external additive to be added is preferably from 0.1 part by weight to 5 parts by weight, and more preferably from 0.3 part by weight to 2 parts by weight with respect to 100 parts by weight of toner particles.

Sieving Step

If necessary, a sieving step may be provided after the above-described external addition step. Specifically, as a sieving method, for example, a gyro shifter, a vibrating sieving machine, a wind classifier or the like is used. Through sieving, coarse particles of the external additive and the like are removed, and thus the formation of streaks on the photoreceptor and trickling down contamination in the apparatus are prevented.

In this exemplary embodiment, an aggregating and coalescing method may be used in which the shape and the particle size of toner particles are easily controlled and the control range in the structure of toner particles such as a core/shell structure is also wide. Hereinafter, a method of preparing toner particles using an aggregating and coalescing method will be described in detail.

The aggregating and coalescing method according to the exemplary embodiment has a dispersion step of forming resin particles (emulsification particles) or the like by dispersing raw materials forming the toner particles, an aggregation step of forming aggregates of the resin particles, and a coalescence step of coalescing the aggregates.

Dispersion Step

A resin particle dispersion may be prepared using a general polymerization method such as an emulsion polymerization method, a suspension polymerization method, or a dispersion polymerization method. Otherwise, a resin particle dispersion may be prepared by applying a shear force to a solution obtained by mixing an aqueous medium with a binder resin using a dispersing machine. In this case, particles may be formed by reducing the viscosity of the resin component by heating. In addition, a dispersant may be used in order to stabilize the dispersed resin particles. Furthermore, when a resin is dissolved in an oily solvent having a relatively low solubility to water, the resin is dissolved in the solvent so that particles thereof are dispersed in the water together with a dispersant or a polymer electrolyte, and then heating or decompression is performed to transpire the solvent, thereby preparing a resin particle dispersion.

Examples of the aqueous medium include water such as distilled water and ion exchange water; and alcohols. Water is preferably used.

Examples of the dispersant that is used in the dispersion step include water-soluble polymers such as polyvinyl alcohol, methyl cellulose, ethyl cellulose, hydroxyethyl cellulose, carboxymethyl cellulose, sodium polyacrylate, and sodium polymethacrylate; surfactants such as anionic surfactants, for example, sodium dodecylbenzenesulfonate, sodium octadecylsulfate, sodium oleate, sodium laurate, and potassium stearate, cationic surfactants, for example, laurylamine acetate, stearyl amine acetate, and lauryl trimethyl ammonium chloride, zwitterionic surfactants, for example, lauryldimethyl amine oxide, and nonionic surfactants, for example, polyoxyethylene alkyl ether, polyoxyethylene alkyl phenyl ether, and polyoxyethylene alkylamine; and inorganic salts such as tricalcium phosphate, aluminum hydroxide, calcium sulfate, calcium carbonate, and barium carbonate.

Examples of the dispersing machine that is used in the preparation of the emulsified liquid include a homogenizer, a homomixer, a pressure kneader, an extruder, and a media-dispersing machine. The size of the resin particles is preferably 1.0 μm or less, more preferably from 60 nm to 300 nm, and still more preferably from 150 nm to 250 nm in terms of the average particle size (volume average particle size). When the size is 60 nm or greater, the resin particles are easily become unstable in the dispersion, and thus the resin particles may easily aggregate. When the size is 1.0 μm or less, the particle size distribution of the toner may be narrowed.

In the preparation of a release agent dispersion, a release agent is dispersed in water, together with an ionic surfactant or a polymer electrolyte such as a polymer acid or a polymer base, and then a dispersion treatment is performed using a homogenizer or a pressure discharge-type dispersing machine with which a strong shear force is applied thereto, simultaneously with heating to a temperature that is not lower than the melting temperature of the release agent. A release agent dispersion is obtained through such a treatment. During the dispersion treatment, an inorganic compound such as polyaluminum chloride may be added to the dispersion. Examples of the preferable inorganic compound include polyaluminum chloride, aluminum sulfate, highly basic polyaluminum chloride (BAC), polyaluminum hydroxide, and aluminum chloride. Among these, polyaluminum chloride, aluminum sulfate, and the like are preferable.

Through the dispersion treatment, a release agent dispersion containing release agent particles having a volume average particle size of 1 μm or less is obtained. More preferably, the volume average particle size of the release agent particles is from 100 nm to 500 nm.

When the volume average particle size is 100 nm or greater, though there is also an influence of the characteristics of the binder resin to be used, generally, the release agent component is easily incorporated in the toner. When the volume average particle size is 500 nm or less, the release agent in the toner has a superior dispersion state.

In order to prepare a brilliant pigment dispersion, a known dispersion method may be used and a general dispersion unit such as a rotary shearing-type homogenizer, a ball mill having media, a sand mill, a Dyno mill, or an Altimizer may be used, and there are no limits to the dispersion unit. The brilliant pigment is dispersed in water, together with an ionic surfactant or a polymer electrolyte such as a polymer acid or a polymer base. The volume average particle size of the dispersed brilliant pigment may be 20 μm or less. The volume average particle size is preferably from 3 μm to 16 μm, since the brilliant pigment in the toner is dispersed well with no impairment in aggregability.

In addition, a brilliant pigment and a binder resin may be dispersed and dissolved to be mixed with each other in a solvent, and dispersed in the water by phase inversion emulsification or shearing emulsification, thereby preparing a dispersion of brilliant pigment particles coated with the binder resin.

Aggregation Step

In the aggregation step, a resin particle dispersion, a brilliant pigment dispersion, a release agent dispersion, and the like are mixed to prepare a mixture, and heated to a temperature that is not higher than the glass transition temperature of the resin particles to aggregate the resin particles, thereby forming aggregated particles. In many cases, in order to form the aggregated particles, the pH of the mixture is adjusted to acidic under stirring. By virtue of the above stirring conditions, the ratio (C/D) may be adjusted in a preferable range. More specifically, in the aggregated particle forming stage, when rapid stirring and heating are performed, the ratio (C/D) may be reduced, and when the stirring speed is reduced and the heating is performed at lower temperature, the ratio (C/D) may be increased. The pH is preferably from 2 to 7, at which an aggregating agent may also be effectively used.

Further, in the aggregation step, the release agent dispersion may be added and mixed together with various dispersions such as a resin particle dispersion at once or in several portions.

As the aggregating agent, a di- or higher-valent metal complex is preferably used, as well as a surfactant having an opposite polarity of the polarity of the surfactant that is used as the dispersant, and an inorganic metal salt. Since the amount of the surfactant to be used may be reduced and the charging properties are improved in the case of using a metal complex, a metal complex is particularly preferably used.

As the inorganic metal salt, aluminum salts and polymers thereof are particularly preferable. In order to obtain a narrower particle size distribution, the valence of the inorganic metal salt is more preferably divalent than monovalent, trivalent than divalent, or tetravalent than trivalent, and further, in the case of the same valences as each other, a polymer-type inorganic metal salt polymer is more suitable.

In this exemplary embodiment, a polymer of tetravalent inorganic metal salt including aluminum is preferably used to obtain a narrow particle size distribution.

In addition, when the aggregated particles have a desired particle size, the resin particle dispersion may be further added (coating step) to prepare a toner having a configuration in which a surface of a core aggregated particle is coated with a resin. In this case, the release agent or the brilliant pigment is not easily exposed to the toner surface, and thus the configuration is preferable from the viewpoint of charging properties or developing property. In the case of further addition, an aggregating agent may be added or the pH may be adjusted before further addition.

Coalescence Step

In the coalescence step, the progression of the aggregation is stopped by increasing the pH of the suspension of the aggregated particles to a range of 3 to 9 under stirring conditions based on the aggregation step, and the aggregated particles are coalesced by heating at a temperature that is not lower than the glass transition temperature of the resin.

In addition, in the case of coating with the resin, the resin is also coalesced and the core aggregated particles are coated therewith. Regarding the heating time, the heating may be performed to the extent that the coalescence is caused, and may be performed for from 0.5 hour to 10 hours.

After coalescence, cooling is performed to obtain coalesced particles. In addition, in the cooling step, crystallization may be promoted by lowering the cooling rate at around the glass transition temperature of the resin (glass transition temperature ±10° C.), that is, so-called slow cooling.

The coalesced particles obtained by coalescence are subjected to a solid-liquid separation step such as filtration, and if necessary, a washing step and a drying step, and thus toner particles are obtained.

For the purpose of adjusting charge, imparting fluidity, imparting charge exchangeability, and the like, an inorganic oxide represented by silica, titania and aluminum oxide may be added and attached to the obtained toner particles as an external additive. A preferable external addition method and a preferable amount of the external additive to be added are as described above.

In addition to the above-described inorganic oxide, other components (particles) such as a charge-controlling agent, organic particles, a lubricant, and an abrasive may be added as external additives.

The charge-controlling agent is not particularly limited, but is preferably colorless or light-colored. Examples thereof include a complex of a quaternary ammonium salt compound, a nigrosine compound, aluminum, or chromium, and a triphenylmethane pigment.

Examples of the organic particles include particles that are generally used as an external additive for the toner surface, such as a vinyl resin, a polyester resin, and a silicone resin. These inorganic or organic particles are used as a fluidity aid, and a cleaning aid, and the like.

Examples of the lubricant include fatty acid amides such as ethylene bis stearic acid amide and oleic acid amide, and fatty acid metal salts such as zinc stearate and calcium stearate.

Examples of the abrasive include silica, alumina, and cerium oxide described above.

Electrostatic Charge Image Developer

An electrostatic charge image developer according to the exemplary embodiment at least includes the toner according to the exemplary embodiment.

The electrostatic charge image developer according to the exemplary embodiment may be a single component developer including only the toner according to the exemplary embodiment or may be a two-component developer obtained by mixing the toner and a carrier.

The carrier is not particularly limited and known carriers may be used. Examples of the carrier include resin coated carriers in which the surface of the core formed of magnetic particles is coated with a resin; magnetic particle dispersion type carriers in which magnetic particles are dispersed and blended in a matrix resin; and resin impregnation type carriers in which porous magnetic particles are impregnated with a resin.

The magnetic particle dispersion type carriers and the resin impregnation type carriers may be carriers in which the constituent particles of the carrier are cores and the surface is coated with a resin.

Examples of the magnetic particles include magnetic metals such as iron, nickel, and cobalt, and magnetic oxides such as ferrite and magnetite.

Examples of the coating resin and the matrix resin include; polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicone resin including organosiloxane bonds and its modified products, fluorine resin, polyester, polycarbonate, phenolic resin, and epoxy resin. The coating resin and the matrix resin may include an additive such as conductive particles.

Examples of the conductive particles include metals such as gold, silver, and copper, and particles of carbon black, titanium oxide, zinc oxide; tin oxide, barium sulfate, aluminum borate, and potassium titanate.

The surface of the core may be coated with the resin by a method of using a coating layer forming solution obtained by dissolving a coating resin and various additives (used if necessary) in an appropriate solvent. The solvent is not particularly limited and may be selected in consideration of the kind of the coating resin to be used, the coating suitability and the like. Specific examples of the resin coating method include a dipping method of dipping cores in a coating layer forming solution, a spraying method of spraying a coating layer forming solution onto surfaces of cores, a fluidized bed method of spraying a coating layer forming solution onto cores in a state in which the cores are allowed to float by flowing air, and a kneader-coater method in which cores of a carrier and a coating layer forming solution are mixed with each other in a kneader-coater and then the solvent is removed.

The mixing ratio (weight ratio) between the toner and the carrier in the two-component developer is preferably from toner:carrier=1:100 to 30:100, and more preferably from 3:100 to 20:100.

Image Forming Apparatus and Image Forming Method

An image forming apparatus and an image forming method according to this exemplary embodiment will be described.

The image forming apparatus according to this exemplary embodiment is provided with an image holding member, a charging unit that charges a surface of the image holding member, an electrostatic charge image forming unit that forms an electrostatic charge image on the charged surface of the image holding member, a developing unit that accommodates an electrostatic charge image developer and develops the electrostatic charge image formed on the surface of the image holding member with the electrostatic charge image developer to forma toner image, a transfer unit that transfers the toner image formed onto the surface of the image holding member to a surface of a recording medium, and a fixing unit that fixes the toner image transferred onto the surface of the recording medium. As the electrostatic charge image developer, the electrostatic charge image developer according to this exemplary embodiment is applied.

In the image forming apparatus according to this exemplary embodiment, an image forming method (image forming method according to this exemplary embodiment) including the steps of: charging a surface of an image holding member; forming an electrostatic charge image on the charged surface of the image holding member; developing the electrostatic charge image formed on the surface of the image holding member with the electrostatic charge image developer according to this exemplary embodiment to form a toner image; transferring the toner image formed onto the surface of the image holding member to a surface of a recording medium; and fixing the toner image transferred onto the surface of the recording medium is performed.

As the image forming apparatus according to this exemplary embodiment, a known image forming apparatus is applied, such as a direct transfer type apparatus that directly transfers a toner image formed on a surface of an image holding member onto a recording medium; an intermediate transfer type apparatus that primarily transfers a toner image formed on a surface of an image holding member onto a surface of an intermediate transfer member, and secondarily transfers the toner image transferred to the surface of the intermediate transfer member onto a surface of a recording medium; an apparatus that is provided with a cleaning unit that cleans a surface of an image holding member before charging after transfer of a toner image; or an apparatus that is provided with an erasing unit that irradiates, after transfer of a toner image, a surface of an image holding member with erase light before charging for erasing.

In the case of an intermediate transfer type apparatus, a transfer unit is configured to have, for example, an intermediate transfer member having a surface to which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to this exemplary embodiment, for example, a part including the developing unit may have a cartridge structure (process cartridge) that is detachable from the image forming apparatus. As the process cartridge, for example, a process cartridge that accommodates the electrostatic charge image developer according to this exemplary embodiment and is provided with a developing unit is suitably used.

Hereinafter, an example of the image forming apparatus according to this exemplary embodiment will be shown. However, the image forming apparatus is not limited thereto. Main portions shown in the drawing will be described, but descriptions of other portions will be omitted.

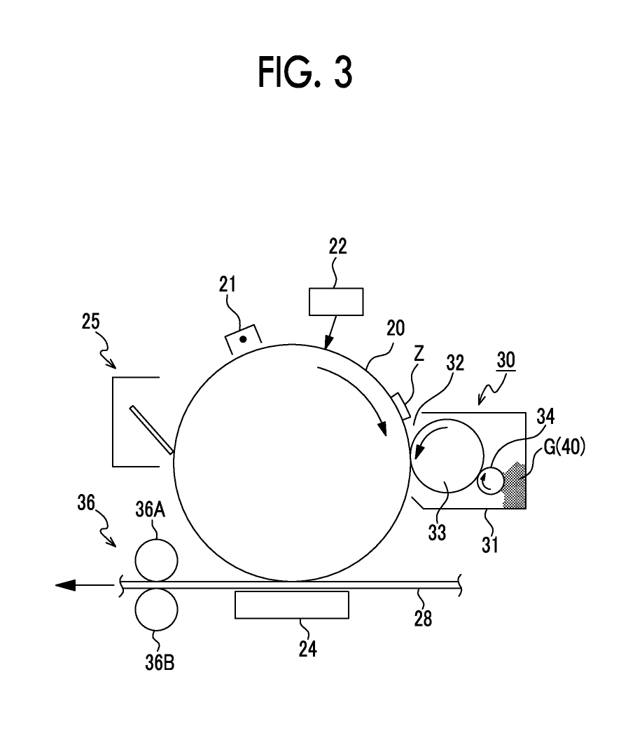

FIG. 3 is a schematic configuration diagram showing an exemplary embodiment of an image forming apparatus including a developing device to which the electrostatic charge image developer according to the exemplary embodiment is applied.

In the drawing, the image forming apparatus according to the exemplary embodiment has a photoreceptor drum 20 as an image holding member that rotates in a predetermined direction, and a charging device 21 that charges the photoreceptor drum 20, an exposing device 22, for example, as a electrostatic charge image forming device that forms an electrostatic charge image z on the photoreceptor drum 20, a developing device 30 that visualizes the electrostatic charge image Z formed on the photoreceptor drum 20, a transfer device 24 that transfers the visualized toner image on the photoreceptor drum 20 onto a recording sheet 28 as a recording medium, and a cleaning device 25 that cleans the toner remaining on the photoreceptor drum 20 are sequentially arranged around the photoreceptor drum 20.

In the exemplary embodiment, as shown in FIG. 3, the developing device 30 includes a developing housing 31 that accommodates a developer G containing a toner 40. In the developing housing 31, an opening 32 for developing facing the photoreceptor drum 20 is opened, and a developing roll (developing electrode) 33 as a toner holding member facing the opening 32 for developing is disposed. When a predetermined developing bias is applied to the developing roll 33, an electric field of developing is formed in an area (developing area) which is an area interposed between the photoreceptor drum 20 and the developing roll 33. In addition, a charge injecting roll (injecting electrode) 34 as a charge injecting member that faces the developing roll 33 is disposed in the developing housing 31. Particularly, in the exemplary embodiment, the charge injecting roll 34 also functions as a toner supply roll that supplies the toner 40 to the developing roll 33.

Herein, the rotation direction of the charge injecting roll 34 may or may not be particularly determined. However, in consideration of the properties relating to the supply of the toner and the characteristics relating to the injection of charge, a constitution is preferable in which the charge injecting roll 34 rotates in the same direction and with a circumferential speed difference (for example, equal to or more than 1:5 times) in a portion facing the developing roll 33 such that the toner 40 is inserted into the area interposed between the charge injecting roll 34 and the developing roll 33, and injects charge while sliding.

Next, the operation of the image forming apparatus according to the exemplary embodiment will be described.

When an image forming process begins, first, the surface of the photoreceptor drum 20 is charged by the charging device 21, the exposing device 22 writes the electrostatic charge image Z on the charged photoreceptor drum 20, and the developing device 30 visualizes the electrostatic charge image Z as a toner image. Subsequently, the toner image on the photoreceptor drum 20 is transported to a transfer portion, and the transfer device 24 electrostatically transfers the toner image on the photoreceptor drum 20 to the recording sheet 28 as a recording medium. The residual toner on the photoreceptor drum 20 is cleaned by the cleaning device 25. Thereafter, the toner image is fixed on the recording sheet 28 by a fixing device 36 provided with a fixing member 36A (a fixing belt, a fixing roll, and the like) and a pressing member 36B and thus an image is obtained.

Process Cartridge and Toner Cartridge

A process cartridge according to the exemplary embodiment will be described.

The process cartridge according to the exemplary embodiment is a process cartridge including a developing unit which accommodates the electrostatic charge image developer according to the exemplary embodiment and develops an electrostatic charge image formed on a surface of an image holding member as a toner image with the electrostatic charge image developer, and is detachable from the image forming apparatus.

Without being limited to the configuration described above, the process cartridge according to the exemplary embodiment may have a configuration including a developing device, and, if necessary, at least one selected from other units such as an image holding member, a charging unit, an electrostatic charge image forming unit, and a transfer unit.

Hereinafter, an example of the process cartridge according to the exemplary embodiment will be shown. However, there is no limitation thereto. Main portions shown in the drawing will be described, but descriptions of other portions will be omitted.

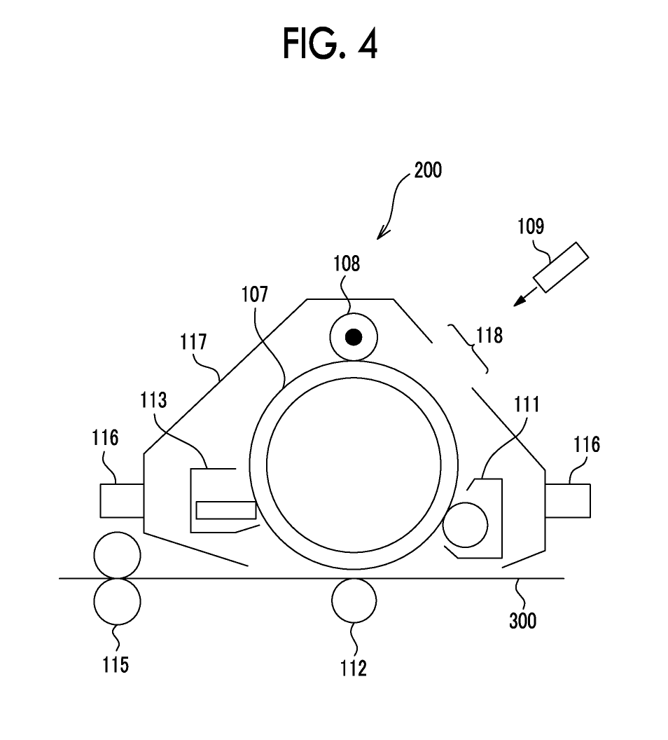

FIG. 4 is a schematic configuration view showing a process cartridge according to an exemplary embodiment.

A process cartridge 200 shown in FIG. 4 is formed as a cartridge having a configuration in which a photoreceptor 107 (an example of the image holding member), a charging roll 108 (an example of the charging unit) provided around the photoreceptor 107, a developing device 111 (an example of the developing unit), and a photoreceptor cleaning device 113 (an example of the cleaning unit) are integrally combined and held by, for example, a housing 117 provided with a mounting rail 116 and an opening 118 for exposure.

In FIG. 4, the reference numeral 109 represents an exposure device (an example of the electrostatic charge image forming unit), the reference numeral 112 represents a transfer device (an example of the transfer unit), the reference numeral 115 represents a fixing device (an example of the fixing unit), and the reference numeral 300 represents a recording sheet (an example of the recording medium).

Next, a toner cartridge according to the exemplary embodiment will be described.

The toner cartridge according to the exemplary embodiment may be configured to accommodate the toner according to the exemplary embodiment and be detachable from an image forming apparatus. The toner cartridge according to the exemplary embodiment may accommodate at least toner and may accommodate, for example, a developer according to the configuration of the image forming apparatus.

The image forming apparatus shown in FIG. 3 is has a configuration from which a toner cartridge (not shown) is freely detachable, and the developing device 30 is connected to the toner cartridge via a toner supply tube (not shown). In addition, when the toner accommodated in the toner cartridge runs low, the toner cartridge may be replaced.

### EXAMPLES

Hereinafter, the exemplary embodiment will be described in detail with reference to examples but the exemplary embodiment is not limited to these examples. In the following description, unless specified otherwise, “part(s)” and “%” are all based on weight.

Preparation of Unmodified Polyester Resin (1)
Terephthalic acid: 1,243 parts
Ethylene oxide adduct of Bisphenol A: 1,830 parts
Propylene oxide adduct of Bisphenol A: 840 parts

The above components are mixed and heated at 180° C., and then 3 parts of dibutyltin oxide are added thereto. The mixture is heated at 220° C. to distill water, and thus an unmodified polyester resin (1) is obtained. The glass transition temperature Tg of the obtained unmodified polyester resin (1) is 60° C., the acid value is 3 mgKOH/g, and the hydroxyl value is 1 mgKOH/g.

Preparation of Polyester Prepolymer (1)
Terephthalic acid: 1,243 parts
Ethylene oxide adduct of Bisphenol A: 1,830 parts
Propylene oxide adduct of Bisphenol A: 840 parts

The above components are mixed and heated at 180° C., and then 3 parts of dibutyltin oxide are added thereto. The mixture is heated at 220° C. to distill water, and thus a polyester prepolymer is obtained. 350 parts of the obtained polyester prepolymer, 50 parts of tolylene diisocyanate, and 450 parts of ethyl acetate are put into a vessel, and the mixture is heated to 130° C. for 3 hours. Thus, a polyester prepolymer (1) having isocyanate groups (hereinafter referred to as “isocyanate-modified polyester prepolymer (1)”) is obtained.

Preparation of Ketimine Compound (1)

50 parts of methyl ethyl ketone and 150 parts of hexamethylenediamine are put into a vessel and stirred at 60° C. to obtain a ketimine compound (1).

Preparation of Crystalline Polyester Resin (1)
1,10-decanedicarboxylic acid: 350 parts
1,4-butanediol: 115 parts

The above-described monomer components are put into a reaction vessel equipped with a stirrer, a thermometer, a condenser, and a nitrogen gas inlet tube, and then the reaction vessel is purged with a dry nitrogen gas. Then, 0.6 parts of tin dioctanoate with respect to 100 parts of the monomer component are added. The mixture is stirred at 150° C. for 3 hours under a nitrogen gas stream and allowed to react, and then the temperature is further raised to 170° C. for 2 hours. The pressure in the reaction vessel is reduced to 3 kPa. While stirring for 2 hours to conduct reaction, the mixture is cooled and the reaction is terminated. Thus, a crystalline polyester resin (1) is obtained.

Preparation of Crystalline Polyester Resin (2)

A crystalline polyester resin (2) is obtained in the same manner as in the preparation of the crystalline polyester resin (1) except that 115 parts of 1,10-decanediol are used instead of 1,4-butanediol.

Preparation of Crystalline Polyester Resin (3)

A crystalline polyester resin (3) is obtained in the same manner as in the preparation of the crystalline polyester resin (2) except that 420 parts of 1,12-dodecanedicarboxylic acid are used instead of 1,10-decanedicarboxylic acid.

Preparation of Crystalline Polyester Resin (4)

A crystalline polyester resin (4) is obtained in the same manner as in the preparation of the crystalline polyester resin (1) except that 280 parts of 1,8-octanedicarboxylic acid are used instead of 1,10-decanedicarboxylic acid and 170 part of 1,6-hexanediol are used instead of 1,4-butanediol.

Preparation of Crystalline Polyester Resin (5)

A crystalline polyester resin (5) is obtained in the same manner as in the preparation of the crystalline polyester resin (1) except that 80 parts of fumaric acid are used instead of 1,10-decanedicarboxylic acid and 220 parts of 1,8-octanediol are used instead of 1,4-butanediol.

Preparation of Brilliant Pigment Dispersion (1)
Aluminum pigment (flake-shaped brilliant pigment, 2173EA, manufactured by Showa Aluminum Powder K.K.):
100 parts Ethyl acetate: 500 parts

The above-described components are mixed, the mixture is filtered, and 500 parts of ethyl acetate are further mixed. This operation is repeated 5 times and then the resultant mixture is dispersed using an emulsifying disperser Cavitron (CR1010, manufactured by Pacific Machinery & Engineering Co., Ltd.) for about 1 hour. Thus, a brilliant pigment dispersion (1) (solid concentration: 10%) in which a brilliant pigment (aluminum pigment) is dispersed is obtained. The average length of the brilliant pigment in the long axis direction is 6.5 μm.

Preparation of Brilliant Pigment Dispersion (2)

A brilliant pigment dispersion (2) is obtained in the same manner as in the preparation of the brilliant pigment dispersion (1) except that a silver-coated glass flake (Metashine 2025, manufactured by Nippon Sheet Glass Co., Ltd., average length in long axis direction: 27 μm) is used instead of an aluminum pigment and a three-one motor with an anchor blade is used for dispersion instead of Cavitron.

Preparation of Release Agent Dispersion (1)
Paraffin wax (melting temperature: 89° C.): 30 parts
Ethyl acetate: 270 parts

The above-described components are wet-pulverized by a microbead disperser (DCP mill) in a state of being cooled to 10° C. to obtain a release agent dispersion (1).

Preparation of Amorphous Polyester Resin (1)

An acid component containing 85% by mole of terephthalic acid and 15% by mole of fumaric acid, an alcohol component containing 50% by mole of a ethylene oxide (2 mol) adduct of bisphenol A and 50% by mole of a propylene oxide (2 mol) adduct of bisphenol A are placed in a 5 L flask equipped with a stirrer, a nitrogen inlet tube, a temperature sensor, and a rectifying column at a ratio of 1:1. The temperature of the mixture is raised up to 80° C. for 2 hours in a nitrogen atmosphere and it is confirmed that the reaction system is uniformly stirred. Thereafter, 0.5 parts of dibutyltin oxide are poured into 100 parts of the mixture. While water formed is distilled away, the temperature of the mixture is raised to 210° C. for 2 hours, and a dehydration condensation reaction is continued at 210° C. for 4 hours, thereby obtaining an amorphous polyester resin (1).

Preparation of Plasticizer Mixed Polyester Resin (1)
Amorphous polyester resin (1): 100 parts
Tripalmitin: 1 part

After confirming that 100 parts of the amorphous polyester resin (1) are heated to 100° C. and melted while stirring, 1 part of tripalmitin is mixed with the resin. The mixture is uniformly stirred. The obtained mixture is cooled and thus a plasticizer mixed polyester resin (1) is obtained.

Preparation of Plasticizer Mixed Polyester Resin (2)

A plasticizer mixed polyester resin (2) is obtained in the same manner as in the preparation of the plasticizer mixed polyester resin (1) except that dibutyl fumarate is used instead of tripalmitin.

Preparation of Nucleating Agent Mixed Polyester Resin (1)
Amorphous polyester resin (1): 100 parts
Sodium benzoate: 1 part

After confirming that 100 parts of the amorphous polyester resin (1) are heated to 100° C. and melted while stirring, 1 part of sodium benzoate is mixed with the resin. The mixture is uniformly stirred. The obtained mixture is cooled and thus a nucleating agent mixed polyester resin (1) is obtained.

Preparation of Nucleating Agent Mixed Polyester Resin (2)

A nucleating agent mixed polyester resin (2) is obtained in the same manner as in the preparation of the nucleating agent mixed polyester resin (1) except that sodium stearate is used instead of sodium benzoate.

Preparation of Oil Phase Liquid (1)
Unmodified polyester resin (1): 136 parts
Crystalline polyester resin (1): 20 parts
Brilliant pigment dispersion (1): 500 parts
Plasticizer mixed polyester resin (1): 5 parts
Nucleating agent mixed polyester resin (1): 5 parts
Ethyl acetate: 56 parts

The above-described components are stirred and mixed, and then 75 parts of the release agent dispersion (1) are added to the obtained mixture, followed by stirring. Thus, an oil phase liquid (1) is obtained.

Preparation of Styrene Acryl Resin Particle Dispersion (1)
Styrene: 370 parts
n-Butyl acrylate: 30 parts
Acrylic acid: 4 parts
Dodecanthiol: 24 parts
Carbon tetrabromide: 4 parts

A mixture obtained by mixing and melting above-described components is dispersed in an aqueous solution in which 6 parts of a nonionic surfactant (Nonipol 400, manufactured by Sanyo Chemical Industries, Ltd.) and 10 parts of an anionic surfactant (Neogen SC, manufactured by DKS Co. Ltd.) are dissolved in 560 parts of ion exchange water, and the dispersion is emulsified in a flask. Then, while mixing the components for 10 minutes, an aqueous solution in which 4 parts of ammonium persulphate are dissolved in 50 parts of ion exchange water are added thereto, and the flask is purged with nitrogen. Then, the content in the flask is heated in an oil bath, while stirring, until the temperature reaches 70° C., and allowed to stand for emulsion polymerization for 5 hours. Thus, a styrene acryl resin particle dispersion (1) obtained by dispersing resin particles having an average particle size of 180 nm and a weight average molecular weight (Mw) of 15,500 (resin particle concentration: 40% by weight) is obtained. The glass transition temperature of the styrene acryl resin particles is 59° C.

Preparation of Water Phase Liquid (1)
Styrene acryl resin particle dispersion (1):60 parts
2% Aqueous Cerogen BS-H solution (manufactured by DKS Co. Ltd.): 200 parts
Ion exchange water: 200 parts

The above-described components are stirred and mixed to obtain a water phase liquid (1).

### Example 1

### Preparation of Toner Particles (1)

Oil phase liquid (1): 300 parts
Isocyanate-modified polyester prepolymer (1): 50 parts
Ketimine compound (1): 5 parts

The above-described components are put into a vessel and stirred for 2 minutes with a homogenizer (Ultra Turrax, manufactured by IKA) and thus an oil phase liquid (1P) is obtained. Then, 1,000 parts of the water phase liquid (1) are added into the vessel and the components are stirred for 20 minutes with the homogenizer. Next, the mixed solution is stirred for 48 hours at room temperature (25° C.) and normal pressure (1 atmosphere) with a propeller-type stirrer. Then, the isocyanate-modified polyester prepolymer (1) is allowed to react with the ketimine compound (1) to forma urea-modified polyester resin. Then, the organic solvent is removed and thus a particulate material is formed. Next, the particulate material is washed with water, dried and classified to obtain toner particles (1). The volume average particle diameter of the toner particles is 12 μm. ASP is 0.24. The toner particle has an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

Preparation of Brilliant Toner (1)

100 parts of the toner particles (1), 1.5 parts of hydrophobic silica (RY50, manufactured by Nippon Aerosil Co. Ltd.), and 0.5 part of hydrophobic silica (R972, manufactured by Nippon Aerosil Co. Ltd.) are mixed using a Henschel mixer at a circumferential speed of 30 m/s for 3 mimutes. Then, the resultant mixture is sieved with a vibration sieve having an opening of 45 μm to obtain a brilliant toner (1).

### Example 2

Toner particles (2) are obtained in the same manner as in the preparation of the toner particles (1) except that the crystalline polyester resin (1) in the oil phase liquid (1) in the preparation of the toner particles (1) is changed to 30 parts of the crystalline polyester resin (2) and the nucleating agent mixed polyester resin (1) is not added. ASP is 0.55. The toner has an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (2) is obtained in the same manner as in the preparation of the brilliant toner (1) except that the toner particles (2) are used.

### Example 3

Toner particles (3) are obtained in the same manner as in the preparation of the toner particles (2) except that the crystalline polyester resin (2) in the oil phase liquid (1) in the preparation of the toner particles (2) is changed to 30 parts of the crystalline polyester resin (3) and 3 parts of the plasticizer mixed polyester resin (2) are added instead of the plasticizer mixed polyester resin (1). ASP is 0.63. The toner has an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (3) is obtained in the same manner as in the preparation of the brilliant toner (1) except that the toner particles (3) are used.

### Example 4

Toner particles (4) are obtained in the same manner as in the preparation of the toner particles (1) except that the crystalline polyester resin (1) in the oil phase liquid (1) in the preparation of the toner particles (1) is changed to 15 parts of the crystalline polyester resin (4) and the plasticizer mixed polyester resin (1) is not added. ASP is 0.23. The toner has an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (4) is obtained in the same manner as in the preparation of the brilliant toner (1) except that the toner particles (4) are used.

### Example 5

Toner particles (5) are obtained in the same manner as in the preparation of the toner particles (1) except that the crystalline polyester resin (1) in the oil phase liquid (1) in the preparation of the toner particles (1) is not added, and the amount of the plasticizer mixed polyester resin (1) is changed to 15 parts, the amount of the nucleating agent mixed polyester resin (1) is changed to 7 parts. The toner has an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (5) is obtained in the same manner as in the preparation of the brilliant toner (1) except that the toner particles (5) are used.

### Example 6

Toner particles (6) are obtained in the same manner as in the preparation of the toner particles (2) except that the amount of the crystalline polyester resin (2) in the oil phase liquid (1) in the preparation of the toner particles (2) is changed to 20 parts, the plasticizer mixed polyester resin (1) is changed to 5 parts of the plasticizer mixed polyester resin (2), and the nucleating agent mixed polyester resin (1) is changed to 7 parts of the nucleating agent mixed polyester resin (2). ΔSP is 0:24. The toner does not have an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (6) is obtained in the same manner as in the preparation of the brilliant toner (1) except that the toner particles (6) are used.

### Example 7

Toner particles (7) are obtained in the same manner as in the preparation of the toner particles (2) except that the amount of the crystalline polyester resin (2) in the oil phase liquid (1) in the preparation of the toner particles (2) is changed to 20 parts, 5 parts of the crystalline polyester resin (5) is added, the plasticizer mixed polyester resin (1) is not added, and the amount of the nucleating agent mixed polyester resin (2) is changed to 3 parts. ASP is 0.55. The toner does not have an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (7) is obtained in the same manner as in the preparation of the brilliant toner (1) except that the toner particles (7) are used.

### Example 8

Toner particles (8) are obtained in the same manner as in the preparation of the toner particles (3) except that the amount of the crystalline polyester resin (3) in the oil phase liquid (1) in the preparation of the toner particles (3) is changed to 10 parts, the amount of the plasticizer mixed polyester resin (2) is changed to 8 parts, and 3 parts of the nucleating agent mixed polyester resin (2) are added. ASP is 0.26. The toner does not have an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (8) is obtained in the same manner as in the preparation of the brilliant toner (1) except that the toner particles (8) are used.

### Example 9

Toner particles (9) are obtained in the same manner as in the preparation of the toner particles (3) except that 2 parts of the nucleating agent mixed polyester resin (2) are added to the oil phase liquid (1) in the preparation of the toner particles (3), the amount of ethyl acetate is changed to 35 parts, and the isocyanate-modified polyester prepolymer (1) and the ketimine compound (1) are not added in the preparation of the toner particles. ΔSP is 0.29. The toner does not have an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (9) is obtained in the same manner as in the preparation of the brilliant toner (1) except that the toner particles (9) are used.

### Example 10

Toner particles (10) are obtained in the same manner as in the preparation of the toner particles (1) except that the brilliant pigment dispersion (1) in the oil phase liquid (1) in the preparation of the toner particles (1) is changed to 100 parts of the brilliant pigment dispersion (2), and the nucleating agent mixed polyester resin (1) is not added. ASP is 0.15. The toner does not have an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (10) is obtained in the same manner as in the preparation of the brilliant toner (1) except that the toner particles (10) are used.

### Comparative Example 1

Toner particles (C1) are obtained in the same manner as in the preparation of the toner particles (1) except that the amount of the unmodified polyester resin (1) is changed to 160 parts, and the crystalline polyester resin (1), the plasticizer mixed polyester resin (1) and the nucleating agent mixed polyester resin (1) are not added in the preparation of the toner particles (1). The toner has an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (C1) is obtained in the same manner as in the preparation of the brilliant toner (1) except that the toner particles (C1) are used.

### Comparative Example 2

Toner particles (C2) are obtained in the same manner as in the preparation of the toner particles (1) except that the crystalline polyester resin (1) in the preparation of the toner particles (1) is changed to 8 parts of the crystalline polyester resin (5), and the plasticizer mixed polyester resin (1) and the nucleating agent mixed polyester resin (1) are not added. ΔSP is 0.06. The toner has an endothermic peak in a range of lower than 50° C. when the temperature is raised from 0° C. to 150° C. in the first temperature rising process in differential scanning calorimetry measurement. An endothermic peak P1 and an endothermic peak P2 are observed in differential scanning calorimetry measurement.

A brilliant toner (C2) is obtained in the same manner as in the preparation of the brilliant toner (1) except that the toner particles (C2) are used.

Measurement and Evaluation

Measurement of Ratio (Q2/Q1)

The ratio (Q2/Q1) of each brilliant toner obtained in the respective examples is measured by the above-described method. The results are shown in Table 1.

Preparation of Developer

36 parts of each of the brilliant toner obtained in the respective examples and 414 parts of a carrier are put into a 2 L V blender and stirred for 20 minutes, and the resultant is then sieved with a sieve having an opening of 212 μm to prepare each developer. As the carrier, a carrier obtained in the following manner is used.

Preparation of Carrier
Ferrite particles (volume average particle diameter: 35 μm): 100 parts
Toluene: 14 parts
Methyl methacrylate-perfluorooctyl ethyl acrylate copolymer (critical surface tension: 24 dyn/cm): 1.6 parts
Carbon black (trade name: VXC-72, manufactured by Cabot Corporation, volume resistivity: 100 Ωcm or less): 0.12 parts
Cross-linked melamine resin particles (average particle diameter: 0.3 μm, insoluble in toluene): 0.3 parts

First, the carbon black is diluted with the toluene and added to the methyl methacrylate-perfluorooctyl ethyl acrylate copolymer, followed by dispersion with a sand mill. Next, in the resultant, the respective above components other than the ferrite particles are dispersed with a stirrer for 10 minutes. Thus, a coating layer forming solution is prepared. Next, the coating layer forming solution and the ferrite particles are put into a vacuum degassing kneader, followed by stirring at a temperature of 60° C. for 30 minutes. Then, the pressure is reduced and the toluene is removed by distillation to form a resin coating layer. Thus, a carrier is obtained.

Evaluation

A developer unit of a modified machine of color 800 press manufactured by Fuji Xerox Co., Ltd. is filled with the obtained developer.

As paper, a sheet of T grain (long grain) A2 gloss coated paper (OK Topcoat paper, manufactured by Oji Paper Co., Ltd., paper weight: 127.9 g/m²) is used.

A solid image having an amount of toner applied of 4.0 g/m² is formed.

The OK Topcoat paper is arranged in the modified machine of color 800 press such that the longitudinal direction of the sheet is directed to a sheet feeding direction.

An image is fixed under the fixing conditions of a fixing belt surface temperature controlled to be 155° C. and a speed of 450 mm/sec using color 800 press.

The obtained brilliant image is used for the following test.

A sheet is cut into a belt shape having a width of 3 cm to the longitudinal direction of the sheet (a direction parallel with the short side of the sheet).

The brilliance 1 (ratio (X/Y)) of an image cut into a belt shape (hereinafter referred to as a belt-shaped image) is measured.

Using a mandrel axis having a diameter of 3 mm of a mandrel method (ISO 1519) measurement device, the rear side (sheet side) of the belt-shaped image is set to the axis side so as to be arranged along the axis. At this time, an angle formed by the longitudinal direction of the belt-shaped image and the mandrel axis becomes a right angle.

The mandrel axis is fixed, and the belt-shaped image is made to reciprocate 100 times (ironing) with a force of 3 kg.

After the ironing, in a state in which the belt-shaped image is interposed between smooth plates and a weight is put thereon, the image is allowed to stand for 24 hours. Thus, the curl formed in the image is corrected.

The brilliance 2 (ratio (X/Y)) of the belt-shaped image after the ironing is measured. In addition, in the case of curl remaining, the belt-shaped image is attached to the smooth plate such that it becomes flat and then, the brilliance is measured.

The ratio between the brilliance 1 and the brilliance (brilliance 2/brilliance 1) is obtained. The obtained results are shown in Table 1.

The measurement of the brilliance 1 and the brilliance 2 is performed in the following manner.

A solid image is irradiated with incident light at an incident angle of −45° with respect to the solid image using a spectro-goniophotometer GC 5000L (manufactured by Nippon Denshoku Industries Co., Ltd.) as a goniophotometer, and a reflectance X at a light-receiving angle of +30° and a reflectance Y at a light-receiving angle of −30° are measured. In addition, the reflectances X and Y are respectively obtained by performing measurement with light in a wavelength range of 400 nm to 700 nm at intervals of 20 nm and calculating the average value of reflectances of the respective wavelengths. The ratio (X/Y) is calculated from the measurement results and the brilliance 1 (ratio (X/Y)) and the brilliance 2 (ratio (X/Y)) are obtained.

In brilliance change function evaluation, when the brilliance ratio (brilliance 2/brilliance 1) is 0.8 or more, the maintenance of brilliance is very excellent and when the brilliance ratio is 0.7 or more and less than 0.8, the brilliance is slightly deteriorated but there is no practical problem.

When the brilliance ratio (brilliance 2/brilliance 1) is less than 0.7, the brilliance is remarkably deteriorated and is inferior.

TABLE 1

Evaluation

| | Toner | Ratio | Brilliance 2/ |
|---|---|---|---|
| | No. | (Q2/Q1) | Brilliance 1 |
| Example 1 | 1 | 0.15 | 0.98 |
| Example 2 | 2 | 0.06 | 0.90 |
| Example 3 | 3 | 0.23 | 0.85 |
| Example 4 | 4 | 0.02 | 0.83 |
| Example 5 | 5 | 0.012 | 0.80 |
| Example 6 | 6 | 0.24 | 0.78 |
| Example 7 | 7 | 0.25 | 0.88 |
| Example 8 | 8 | 0.26 | 0.81 |
| Example 9 | 9 | 0.29 | 0.76 |
| Example 10 | 10 | 0.15 | 0.74 |
| Comparative | C1 | 0.002 | 0.66 |
| Example 1 | | | |
| Comparative | C2 | 0.55 | 0.59 |
| Example 2 | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A brilliant toner, comprising:
a brilliant pigment; and
a binder resin that includes at least one amorphous resin and at least one crystalline resin,
wherein at least one crystalline resin is an aliphatic crystalline resin that includes a constituent unit derived from an aliphatic: diol having a carbon chain length of 2 to 20 and a constituent unit derived from an aliphatic dicarboxylic acid having a carbon chain length of 2 to 20,
wherein the brilliant pigment is at least one selected from the group consisting of aluminum, brass, bronze, nickel, stainless steel, and zinc powders, mica, barium sulfate, layered silicate and layered aluminum silicate coated with titanium oxide or yellow iron oxide, single-crystal planar titanium oxide, basic carbonates, acid bismuth oxychloride, natural guanine, foil-shaped glass powder, and metal-deposited foil-shaped glass powder, and
wherein, when the toner is subjected to a differential scanning calorimetry measurement which is performed by raising a temperature of the toner from 0° C. to 150° C. in a first temperature rising process, cooling the temperature from 150° C. to 0° C., and then raising the temperature from 0° C. to 150° C. in a second temperature rising process,
the toner exhibits an endothermic peak P1 in a range of 50° C. to 65° C. in the first temperature rising process,
an endothermic peak P2 in a range of 50° C. to 65° C. in the second temperature rising process, and
a ratio (Q2/Q1) between a total endothermic quantity Q1 in a range of 50° C. to 65° C. in the first temperature rising process and a total endothermic quantity Q2 in a range of 50° C. to 65° C. in the second temperature rising process is from 0.01 to 0.30.

2. The brilliant toner according to claim 1,
wherein an average length of the brilliant pigment in a long axis direction is from 1 μm to 20 μm.

3. (canceled)

4. (canceled)

5. (canceled)

6. The brilliant toner according to claim 1,
wherein an absolute value ΔSP of a difference between a solubility parameter of the crystalline resin and a solubility parameter of the amorphous resin is from 0.2 to 0.7.

7. The brilliant toner according to claim 1,
which further comprises at least one selected from the group consisting of phthalic acid ester, isophthalic acid ester, trimellitic acid ester, adipic acid ester, phosphoric acid ester, palmitic acid ester, a polyester resin having a weight average molecular weight of less than 5,000, and a liquid paraffin.

8. The brilliant toner according to claim 1,
which further comprises at least one selected from the group consisting of metal salts of benzoic acid, metal salts of stearic acid, metal salts of phosphoric acid ester, metal salts of oxalic acid, sorbitol compounds, carbon black, metal oxides, kaolin, and talc.

9. The brilliant toner according to claim 1,
wherein the toner does not exhibit an endothermic peak in a range of lower than 50° C. when the temperature is increased from 0° C. to 150° C. in the first temperature rising process in the differential scanning calorimetry measurement.

10. The brilliant toner according to claim 1,
wherein the toner includes aluminum as the brilliant pigment.

11. The brilliant toner according to claim 1,
wherein a portion insoluble in toluene except for an inorganic substance is from 0.1% by weight to 50% by weight with respect to a total amount of the toner.

12. The brilliant toner according to claim 1,
wherein the toner includes a urea-modified polyester resin as the binder resin.

13. The brilliant toner according to claim 1,
wherein a melting temperature of the crystalline resin is from 60° C. to 85° C.

14. The brilliant toner according to claim 1,
wherein a weight average molecular weight (Mw) of the crystalline resin is from 6,000 to 35,000.

15. The brilliant toner according to claim 1,
wherein the brilliant pigment has an aspect ratio of 5 to 200.

16. The brilliant toner according to claim 1,
wherein a ratio (C/D) between an average maximum thickness C and an average equivalent circle diameter D of the toner is from 0.001 to 0.500.

17. The brilliant toner according to claim 1,
wherein a proportion of brilliant pigment arranged so that an angle formed by a long axis direction of a toner particle in the cross section and a long axis direction of the brilliant pigment is in a range of −30° to +30° is equal to or greater than 60% of the total number of brilliant pigment particles.

18. An electrostatic charge image developer comprising:
the brilliant toner according to claim 1.

19. A toner cartridge that accommodates the brilliant toner according to claim 1 and is detachable from an image forming apparatus.

20. The brilliant toner according to claim 1,
wherein the aliphatic acid has a carbon chain length of 4, 8, 10 or 12, and the aliphatic diol has a carbon chain length of 6, 8 or 9.
